(19) United States
(12) Patent Application Publication
(10) Pub. No.: US 2001/0039504 A1
(43) Pub. Date: Nov. 8, 2001

(54) Individualized, integrated and informative internet portal for holistic management of patients with implantable devices

(76) Inventors: Kurt R. Linberg, Eden Prairie, MN (US); James D. Webb, Maple Grove, MN (US); JoAnn Abraham, Coon Rapids, MN (US)

Correspondence Address: GIRMA WOLDE-MICHAEL, Medtronic, Inc., MS 301, 7000 Central Avenue NE, Minneapolis, MN, 55432, US

(21) Appl. No.: 09/809,483

(22) Filed: Mar. 15, 2001

Related U.S. Application Data
(60) Provisional application No. 60/189,562, filed on Mar. 15, 2000.

(51) Int. Cl. G06F 17/60

(52) U.S. Cl. 705/3

(57) ABSTRACT

The present invention provides for a software-based system that may use Internet and World Wide Web technologies to present an individualized and integrated view of information associated with implantable device patients. The invention provides for a data communications portal for a medical professional to assess not only the information supplied by an implantable device, but also integrate data from other data sources, including but not limited to medication records and lab records. The portal may be individualized for each user; each user being enabled to view only the information that they had access privileges to see.

### FIELD OF THE INVENTION

The present invention generally relates to implantable medical devices (IMDs). Specifically, the invention relates to real-time communication between patients, physicians, and the IMDs to assist the patients in participating in their own clinical care and therapy. More specifically the invention relates to highly specialized web-based data resources to capture, analyze, package, synthesize and display patient-specific information on demand, in real-time.

### BACKGROUND OF THE INVENTION

Optimally, a technology-based health care system that fully integrates the technical and social aspects of patient care and therapy should be able to flawlessly connect the client with care providers irrespective of separation distance or location of the participants. While clinicians will continue to treat patients in accordance with accepted modern medical practice, developments in communications technology are making it ever more possible to provide medical services in a manner independent of time and location.

Prior art methods of clinical services are generally limited to in-hospital operations. For example, if a physician needs to review the performance parameters of an implantable device in a patient, it is likely that the patient has to go to the clinic. Further, if the medical conditions of a patient with an implantable device warrant a continuous monitoring or adjustment of the device, the patient would have to stay in a hospital indefinitely. Such a continued treatment plan poses both economic and social problems. Under the exemplary scenario, as the segment of the population with implanted medical devices increases many more hospitals, clinics, and service personnel will be needed to provide in-hospital service for the patients, thus escalating the cost of healthcare. Additionally, the patients will be restricted and inconvenienced by the need to either stay in the hospital or make very frequent visits to a clinic.

Yet another condition of the prior art practice requires that a patient visit a clinic center for occasional retrieval of data from the implanted device to assess the operations of the device and gather patient history for both clinical and research purposes. Such data is acquired by having the patient in a hospital/clinic to down load the stored data from the implantable medical device. Depending on the frequency of data collection, this procedure may pose serious difficulty and inconvenience for patients who live in rural areas or have limited mobility. Similarly, in the event a need arises to upgrade the software of an implantable medical device, the patient will be required to come into the clinic or hospital to have the upgrade installed. Further, in medical practice it is an industry-wide standard to keep an accurate record of past and contemporaneous procedures relating to an IMD uplink, i.e. a communications session with, for example, a programmer device. The report is required to contain the identification of all the medical devices involved in any interactive procedure. Specifically, all peripheral and major devices that are used in down-linking to the IMD need to be reported. Currently, such procedures are manually reported and require an operator or a medical person to diligently enter data during each procedure. One of the limitations of the problems with the reporting procedures is the fact that it is error-prone and requires rechecking of the data to verify accuracy.

Yet a further limitation of the prior art relates to the operator-programmer interface. Generally a medical device manager/technician should be trained on the clinical and operational aspects of the programmer device. Current practice requires that an operator attend a class/session sponsored by a clinic, hospital, or the manufacturer to successfully manage a programmer-IMD procedure. Further, the operator should be able to keep abreast of new developments and new procedures in the management, maintenance, and upgrade of the IMD. Accordingly, it is imperative that operators of programmers, IMDs, and related medical devices be trained on a regular basis.

IMDs, programmers, and related medical instruments are distributed throughout the world. Additionally, the number of people with implanted medical devices has been increasing over the last few years. Thus, it is impractical to request operators of these globally distributed medical devices to attend training sessions further away from their geographical location. Specifically, at current global distribution levels training centers will need to be located throughout the world. Clearly, such a solution is both expensive and impractical.

A further limitation of the prior art relates to the management of multiple medical devices in a single patient. Advances in modern patient therapy and treatment have made it possible to implant a number of devices in a patient. For example, IMDs such as a defibrillator or a pacer, a neural implant, a drug pump, a separate physiologic monitor, and various other IMDs may be implanted in a single patient. To successfully manage the operations and assess the performance of each device in a patient with multiple implants requires a continuous update and monitoring of the devices. Further, it may be preferred to have an operable communication between the various implants to provide a coordinated clinical therapy to the patient. Thus, there is a need to monitor the IMDs including the programmer on a regular, if not a continuous, basis to ensure optimal patient care. In the absence of other alternatives, this imposes a great burden on the patient if a hospital or clinic is the only center where the necessary upgrade, follow up, evaluation and adjustment of the IMDs could be made. Further, even if feasible, the situation would require the establishment of multiple service areas or clinic centers to support the burgeoning number of multi-implant patients worldwide.

Accordingly, it would be desirable to have a programmer unit that would connect to a remote expert data center, a remote web-based data center or a remote data center, all these terms being alternate equivalents as used herein, to provide access to an expert system and import the centrally-based expertise to a local environment. Further, it is important to have a local program operator/manager or technician who could be trained remotely by exporting a software-based training regimen, from a remote web-based data center, with automated features to provide on-site certification generation, certification notification and enabling software. More specifically, it is most desirable to provide globally-distributed technicians of programmers and software-based training which would train, test and certify the technician consistent with the standards set by the manufacturer of the IMD and programmer and in compliance with the certification regulation of the country in which the technician is located.

The proliferation of patients with multi-implant medical devices worldwide has made it desirable to provide remote services to the IMDs and timely clinical care to the patient. Frequent use of programmer devices to communicate with the IMDs and provide various remote services, consistent with co-pending applications titled “System and Method for Transferring Information Relating to an Implantable Medical Device to a Remote Location,” filed on Jul. 21, 1999, Ser. No. 09/358,081; “Apparatus and Method for Remote Troubleshooting, Maintenance and Upgrade of Implantable Device Systems,” filed on Oct. 26, 1999, Ser. No. 09/426,741; “Tactile Feedback for Indicating Validity of Communication Link with an Implantable Medical Device,” filed Oct. 29, 1999, Ser. No. 09/430,708; “Apparatus and Method for Automated Invoicing of Medical Device Systems,” filed Oct. 29, 1999, Ser. No. 09/430,208; “Apparatus and Method for Remote Self-Identification of Components in Medical Device Systems,” filed Oct. 29, 1999, Ser. No. 09/429,956; “Apparatus and Method to Automate Remote Software Updates of Medical Device Systems,” filed Oct. 29, 1999, Ser. No. 09/429,960; “Method and Apparatus to Secure Data Transfer From Medical Device Systems,” filed Nov. 2, 1999, Ser. No. 09/431,881; “Implantable Medical Device Programming Apparatus Having An Auxiliary Component Storage Compartment,” filed Nov. 4, 1999, Ser. No. 09/433,477; “Remote Delivery Of Software-Based Training For Implantable Medical Device Systems,” filed Nov. 11, 1999, Ser. No. 09/437,615_; “Apparatus and Method for Remote Therapy and Diagnosis in Medical Devices Via Interface Systems,” filed Dec. 14, 1999, Ser. No. 09/460,580; “Virtual Remote Monitor, Alert, Diagnostics and Programming For Implantable Medical Device Systems” filed Dec. 17, 1999, Ser. No. 466,284; which are all incorporated by reference herein in their entirety, has become an important aspect of patient care. Thus, in light of the enclosed disclosures, the present invention provides a vital system and method of dispensing/delivering efficient therapy and clinical care to the patient.

### SUMMARY OF THE INVENTION

The present invention provides for a software-based environment that uses data communication systems or networks, including the Internet and World Wide Web technologies, to present an individualized and integrated view of information associated with implantable device patients. Medical professionals require integrated data to manage their patients. Implantable devices can supply robust data associated with the patient, but it is only a part of the data required for assessing the state of the patient. The invention provides for a “portal” or communications environment for a medical professional to assess not only the information supplied by an implantable device, but also integrate data from other data sources, including but not limited to medication records and lab records. The portal may be individualized for each user. A specific doctor can have his/her portal arranged with the information that he/she prefers. The portal may also be accessible by research and development personnel, sales personnel, executives, and patients. In a preferred embodiment, each user would only see the information that they had access privileges to see.

The present invention provides for an inexpensive and practical way for a physician to review the performance parameters of an implantable device in a patient without the patient going to the clinic or staying in a hospital indefinitely. In addition, the errors caused by the manual reporting procedures are significantly reduced and the labor-intensive task of verifying data accuracy is eliminated. By utilizing a communications portal in accordance with the present invention, the operators of programmers, IMDs, and related medical devices can be trained globally on a regular basis without expensive travel costs. Further, a device or interface operator can successfully manage the operations and assess the performance in a patient with multiple implants.

Therefore, it is one aspect of the present invention to provide for real-time communication between patients and the IMDs to assist patients in participating in their own clinical care and therapy, via a networked or other data-communications system. For example, the present invention may be implemented over the Internet using a secure protocol. More specific objects of the invention are to provide for a technology-based health care system that fully integrates the technical and social aspects of patient care and therapy by connecting the client with care providers irrespective of separation distance or location of the participants; to provide for a remote secure site, such as an Internet site, providing various clinical, therapy and related information/services to patients, or to enable a patient to uplink their IMDs and transfer data into a data management center where the data may be analyzed, with relevant therapy/clinical care dispensed accordingly; to provide for a specialized web-based data resource system to capture, analyze, package, synthesize, and display patient-specific information on demand, in real-time; to provide for arrhythmia management via programmable patient arrhythmia notification devices in the IMDs, which cooperate with a remote data management center; to provide for a data management system for IMDs, which may allow patients to access a specialized web site using the IMDs serial number; to provide for an inexpensive and practical method of continuously monitoring medical conditions of a patient, or the adjustment of IMD devices; to eliminate the limitations of manual reporting procedures such as data reporting errors, data verification, and the manual inputting of data for each procedure; to provide for an inexpensive and efficient method for training operators of programmers, IMDs, and related medical devices on a regular or continuous basis, for example, by exporting a software-based training regimen from a remote web-based data center with automated features to provide on site certification generation, certification notification and enabling software; to provide globally distributed technicians of programmers and software-based training which would train, test and certify the technician consistent with the standards set by the manufacturer of the IMD and programmer in compliance with the certification regulation of the country in which the technician is located; to provide for managing the operations and assessing the performance of each device in a patient with multiple implants, and to provide for a programmer unit that connects to a remote expert data center, or a remote data center for providing access to an expert system and importation of the expertise to the local environment.

### BRIEF DESCRIPTION OF THE DRAWINGS

FIGS. 1-2 are interface views of an implementation of a summary web page according to an embodiment of the present invention.

FIG. 3 is a flow diagram showing the patient portal website user interfaces.

FIG. 4 is an architecture diagram showing the patient portal information section user interfaces.

FIG. 5 is an architecture diagram showing the patient portal records section user interface.

FIG. 6 is an architecture diagram showing the patient portal contacts section user interfaces.

FIG. 7 is a an architecture diagram showing the patient portal patient account section user interfaces.

FIG. 8 is an architecture diagram showing physician portal user interfaces.

FIG. 9 is an architecture diagram showing the physician portal information section user interfaces.

FIG. 10 is an architecture diagram showing the physician portal records section user interfaces.

FIG. 11 is an architecture diagram showing the physician portal physician's practice section user interfaces.

FIG. 12 is an architecture diagram showing the physician portal connect section user interfaces.

FIG. 13 is an architecture diagram showing the physician portal accounts section user interfaces.

FIG. 14 is an architectural representation of the data flows between patient data and relevant patient records.

FIG. 15 is a interface view of an implementation of patient/physician portal login interface.

FIG. 16 is a top portion interface view of an implementation of a welcome interface.

FIG. 17 bottom portion interface view of an implementation of a welcome interface.

FIG. 18 is a top portion interface view of an implementation of the information interface.

FIG. 19 is a bottom portion interface view of an implementation of the information interface.

FIG. 20 is a top portion interface view of an implementation of the about device manufacturer interface.

FIG. 21 is a bottom portion interface view of an implementation of the about device manufacturer interface.

FIG. 22 is a interface view of an implementation of a frequently asked questions interface.

FIG. 23 is a interface view of an implementation of a links interface.

FIG. 24 is a interface view of an implementation of a what's new interface.

FIG. 25 is a interface view of an implementation of a home monitoring status interface.

FIG. 26 is a interface view of an implementation of a medications interface.

FIG. 27 is a interface view of an implementation of a schedule interface.

FIG. 28 is a interface view of an implementation of a patient diary interface.

FIG. 29 is a interface view of an implementation of a detailed records interface.

FIG. 30 is a interface view of an implementation of a contact your doctor interface.

FIG. 31 is a interface view of an implementation of a patient discussion groups interface.

FIG. 32 is a interface view of an implementation of a patient advisory groups interface.

FIG. 33 is a interface view of an implementation of a find a doctor interface.

FIG. 34 is a top portion interface view of an implementation of the support group interface.

FIG. 35 is a bottom portion interface view of an implementation of the support group interface.

FIG. 36 is a interface view of an implementation of the contact device manufacturer interface.

FIG. 37 is a top portion interface view of an implementation of the personal information interface.

FIG. 38 is a bottom portion interface view of an implementation of the personal information interface.

FIG. 39 is a interface view of an implementation of the patient identification card interface.

FIG. 40 is a interface view of an implementation of the share records interface.

FIG. 41 is a interface view of an implementation of the change password interface.

FIG. 42 is a interface view of an implementation of the private policy interface.

FIG. 43 is a interface view of an implementation of the patient/physician portal website login interface.

FIG. 44 is a interface view of an implementation of the physician welcome interface.

FIG. 45 is a interface view of an implementation of the information interface.

FIG. 46 is a interface view of an implementation of the online courses interface.

FIG. 47 is a interface view of an implementation of the educational materials interface.

FIG. 48 is a interface view of an implementation of the frequently asked questions interface.

FIG. 49 is a interface view of an implementation of the manuals interface.

FIG. 50 is a interface view of an implementation of the specifications database interface.

FIG. 51 is a interface view of an implementation of the literature abstract search interface.

FIG. 52 is a interface view of an implementation of the medical links interface.

FIG. 53 is a interface view of an implementation of the patient records interface.

FIG. 54 is a interface view of an implementation of the patient scheduling interface.

FIG. 55 is a interface view of an implementation of the billing interface.

FIGS. 56-60 are interface views of an implementation of the device registration interface.

FIG. 61 is a interface view of an implementation of the clinical studies interface.

FIGS. 62-64 are interface views of an implementation of the compare your practice interface.

FIGS. 65-66 are interface views of an implementation of the patient and device tracking interface.

FIGS. 67-68 are interface views of an implementation of the referring physician reports interface.

FIG. 69 is a interface view of an implementation of the cardiovascular alliance views interface.

FIG. 70 is a interface view of an implementation of the guidelines and protocols interface.

FIGS. 71-72 are interface views of an implementation of the product performance interface.

FIG. 73 is a interface view of an implementation of the contact device manufacturer interface.

FIG. 74 is a interface view of an implementation of the remote viewing interface.

FIG. 75 is a interface view of an implementation of the remote in-home programming interface.

FIG. 76 is a interface view of an implementation of the email interface.

FIGS. 77-78 are interface views of an implementation of the discussion groups interface.

FIG. 79 is a interface view of an implementation of the patient access control interface.

FIG. 80 is a interface view of an implementation of the patient record access control interface.

FIGS. 81-84 are interface views of an implementation of the reporting a and notification preferences interface.

FIG. 85 is a interface view of an implementation of the change password interface.

### DETAILED DESCRIPTION OF PREFERRED EMBODIMENT

To assist in an understanding of the invention, a preferred embodiment or embodiments will now be described in detail. Reference will be frequently taken to the drawings, which are summarized above. Reference numerals will be used to indicate certain parts and locations in the drawings. The same reference numerals will be used to indicate the same parts or locations throughout the drawings unless otherwise indicated.

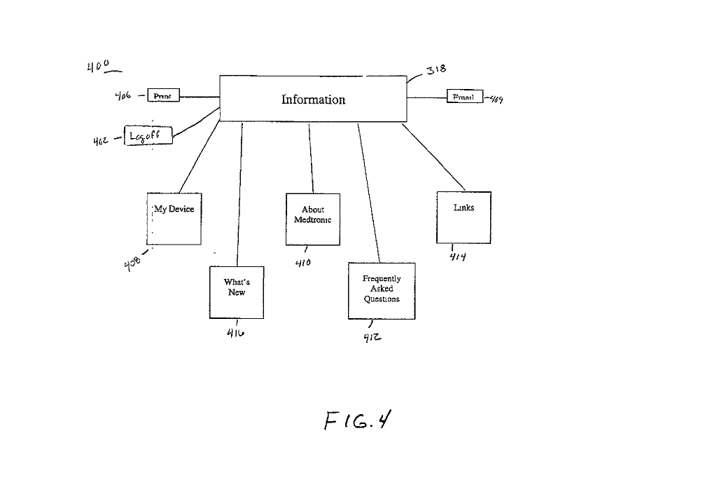

With reference to FIG. 3, patient/physician portal 300 is a data communications interface, e.g., a secure web site, for a patient already implanted with a medical device. The medical device can be any of that know in the art including but not limited to such devices as a defibrillator or a pacer, a neural implant, or a drug pump. Patient portal 300 preferably is personalized, automatically providing only information pertinent to a patient's device and disease. Because portal 300 contains personal information specific to a patient access to portal 300 requires secure access such as encryption, tunneling, secure socket layer connection, a direct dial-up connection, or a dedicated line.

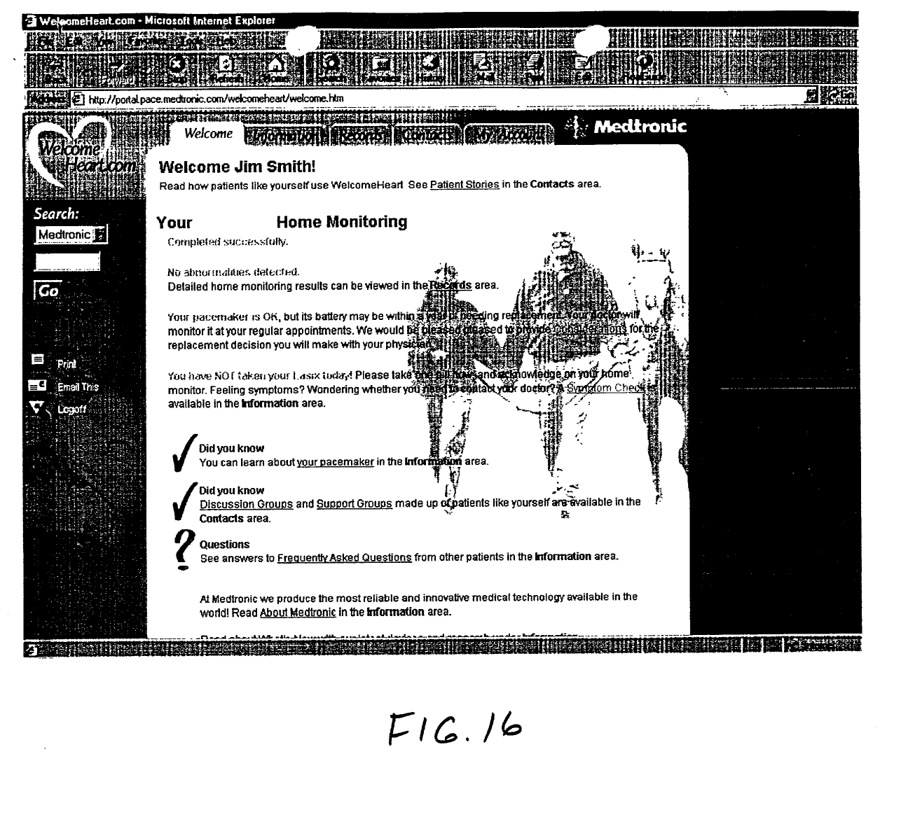

With further reference to FIG. 3, an architecture diagram of patient portal 300 is shown. An overview of a typical patient session is shown in the architecture diagram of FIG. 3. Prior to the start of a patient session a patient contacts the patient portal interface (step 302) in one of various data communications means, such as connecting via the Internet on a home computer modern or via a local area network (LAN) at work, or via a direct dial-up connection to a portal server or by dedicated line. After data communications are established, the patient may contact patient portal 300 through a web browser, html reader, or other communications interface, e.g., by inputting the URL of patient portal server directory or file into the web address bar. The server file may preferably be implemented in html. Preferably, the patient has the option to go directly to the patient portal where they can then link to, for example, a login interface 1500 (FIG. 15) or the patient can directly input portal login interface's 1500 URL or network or directory location and go directly to patient portal login interface 1500.

Regardless of how the patient arrives at patient portal login 1500, preferably once connected to patient portal 300 the patient may then log into patient portal 300 (step 304) at login interface 1500. Login interface 1500 preferably allows access to patient portal 300 when the patient enters a user id and password specific to the patient. Since login page 1500 accepts user ids and passwords, page 1500 is preferably encrypted, tunneled, or otherwise configured to ensure secure transmission of the entered passwords rather than plaintext transmission. In an Internet embodiment of the present invention, interface 1500 can be accessed by anyone; therefore, it will preferably contain minimal content to further ensure security. In addition, interface 1500 will accommodate both weak authentication (i.e., passwords) and strong authentication, e.g., token-based authentication, kerberos tickets, or PKI authentication. A patient login in with weak authentication will have access to mildly secure features, while those with a strong login can view all content. Therefore, the amount of content viewable by the user will be determined by who the user is. Further, for increased security and patient compliance, the patient's physician may be able to control what information to which the patient will have access.

At login interface 1500, the patient may enter a user id specific to the patient in user id box 1502. The patient may also be prompted to enter a password specific to the patient in password box 1504. When the patient has inputted a user id and password, the patient preferably will be able to utilize a mouse to click on enter button 1506 or the user can also press the return button on the keyboard to input their user id and password. With reference to FIG. 3, the patient portal server must determine if the patient has properly inputted the correct user id and password (step 306). If the patient has improperly inputted either the user id or the password (step 308) then the patient is directed back to login interface 1500 where the patient can reenter their user id and password (step 304).

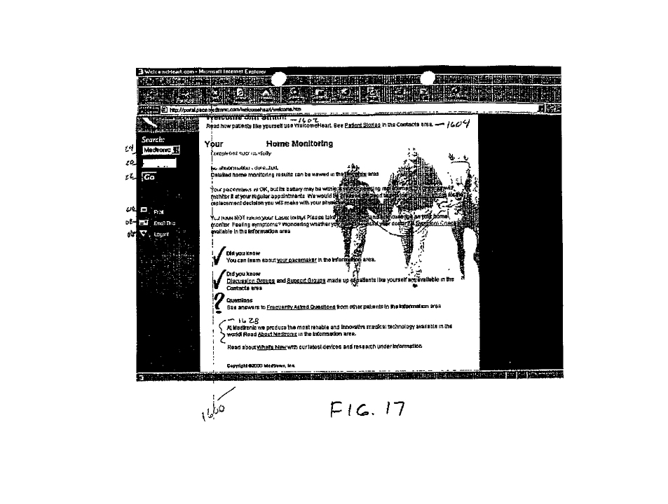

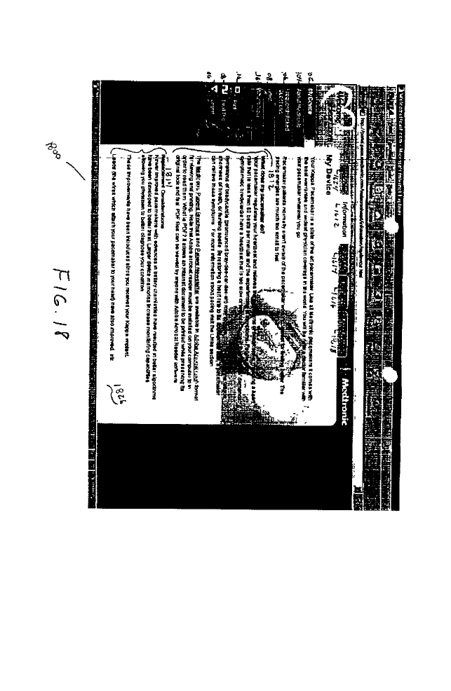

If the patient's user id and password were inputted correctly then the patient may be sent to patient welcome interface 1600 (FIG. 16 and 17) (step 312). However, before the patient arrives at welcome interface 1600 the patient portal is preferably automatically customized (step 310) to the patient. Therefore, when the patient arrives at welcome interface 1600, patient dependent information may be displayed in a user-friendly manner.

With reference to FIGS. 16 and 17, welcome interface 1600 may include such features as, for example, patient's name 1602 appearing in welcome message 1604; a listing of all devices 1626 the patient has implanted and any relevant information concerning these devices; and marketing preferences 1628 of what news or new products may be of interest to the patient. Information personal to the patient can be obtained through a patient registration process.

Since no patient private data appears on welcome interface 1600 only weak authentication (i.e., password) will be necessary to obtain access to welcome interface 1600.

Welcome interface 1600 offers a plurality of web links, which may include Logoff link 1606; Email link 1608; Print link 1610; Information link 1612; Records link 1614; Contacts link 1616; My account link 1618; and Welcome link 1624. Each one of links 1606-1624 will preferably transfer the patient to another web page or server directory or file that contains patient and IMD information. In a preferred embodiment, a search box 1620 is provided where the patient can input a key word or phrase, which the patient desires information on, and then click on “Go” button 1622. A search engine running on the portal server will then attempt to locate relevant information based upon the key word or phrase that the patient has inputted. It should be noted the information returned from the search engine would also be limited on a security basis depending on the patient's login authentication. The search engine could also be expanded to search other servers up to and including the entire web. The patient can accomplish this by using scroll bar 1626 and choosing the server or network area that they would like to search.

If the patient desires to logoff, then they merely click on logoff link 1606. Upon clicking of logoff link 1606 the patient is linked, e.g., via an html link tag, to login interface 1500 (step 314 FIG. 3).

Email link 1608 gives the patient the ability to email via SMTP, or otherwise transmit via another communication protocol, to a friend or family member, a copy of the server content that the user is currently viewing. If the patient desires to email anyone then they click on email link 1608 and this links the patient to a server email utility, the local computer's email program, or any other method of email known to those skilled in the art (step 316). Further, the email function is provided for much of patient portal 300.

If the patient desires to print the server content they are viewing then they merely need to click on print link 1610 (step 316). The ability to print will be provided for most pages depending on the level of security for the web page. On some pages the print function (step 318) will print directly, on others it will preferably invoke a printer friendly version of the content. Regardless of the page being printed the print setup is preferably a function of the user's local computer, not patient portal server 300.

By clicking on information link 1612 the patient may be linked to information server file 1800 (step 320 FIG. 3). By clicking on records link 1614 the patient is linked to records server file 2500 (step 322 FIG. 3). By clicking on contacts link 1616 the patient may be linked to contacts server file 3000 (step 324 FIG. 3). By clicking on my accounts link 1616 the patient may be linked to my accounts server file 3700 (step 326 FIG. 3). Each one of these server files, e.g., web pages, is disused in detail below. If the patient clicks on welcome link 1624 the patient is linked to welcome interface 1600 (step 312 FIG. 3).

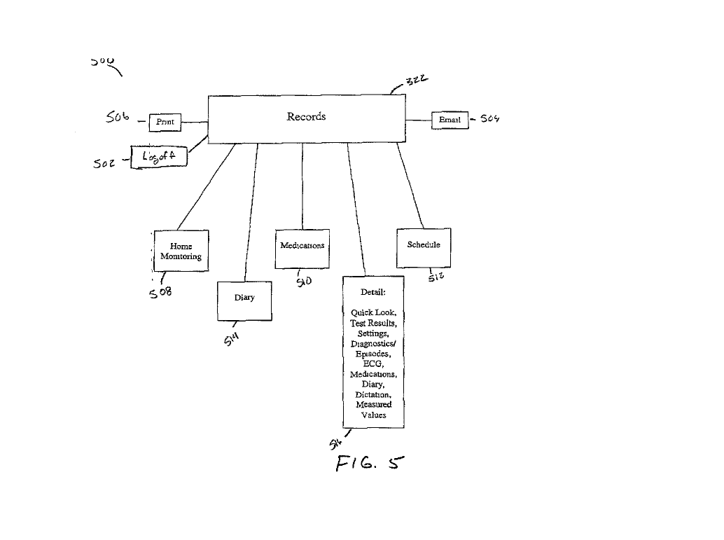

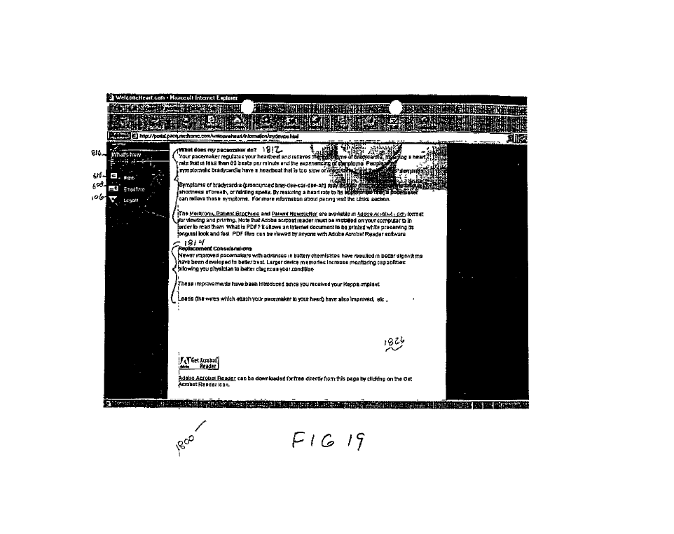

With respect to FIG. 4, information web page architecture diagram 400 is shown. After clicking on information link 1612 the patient may be linked to information server file 1800 (step 318). With respect to FIG. 18 and 19, information server file 1800 preferably offers more server or network links including, for example, My device link 1802; About Medtronic 1804; Frequently asked questions link 1806; Links link 1808; What's new link 1810.

Steps 402, 404, and 406 are substantially the same as steps 314, 316, and 318 respectively and therefore reference may be made to the operation of links 1606-1610 discussed above. Further, links 1612, 1614, 1616, 1618, and 1624 function substantially the same on information interface 1800 as they did on welcome interface 1600.

When the patient first arrives at information server file 1800, my device server file 1826 is displayed (step 408 FIG. 4). My device server file 1826 preferably presents a high-level overview 1812 of the patient's implanted device or devices 1812. The patient can read, see a picture, or send this information to friends or family members (step 404). Since a patient can access information related to their implanted devices there is the potential to reduce the information dissemination burden on clinicians and the IMD manufacturer, and promote brand awareness. Further, since device overview information 1812 is not sensitive and will only be duplicating information already available publicly there are no security concerns for my device web page 1826 except to the extent that the device information may be linked to the patient accessing overview information 1812.

My device server file 1826 also displays replacement consideration information 1814 for the patient to consider if a replacement may ever be necessary. Replacement information 1814 is customized by, for example, Logic concerning what devices the patient has implanted; Logic based on estimated device longevity; Marketing; and Physician control over what information the patient has access to. Replacement consideration information 1814 may potentially be sensitive. Therefore, if patient specific information can be derived from my device interface 1826 then it may require encryption.

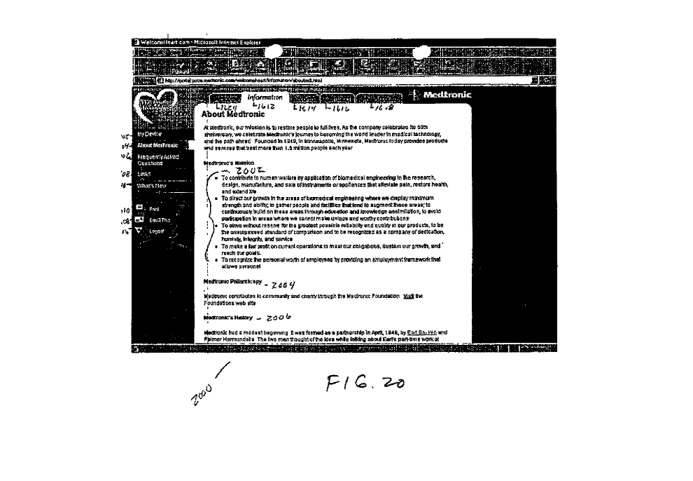

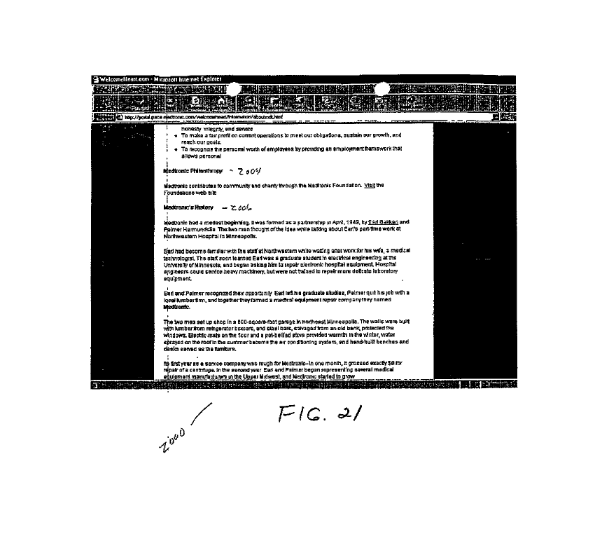

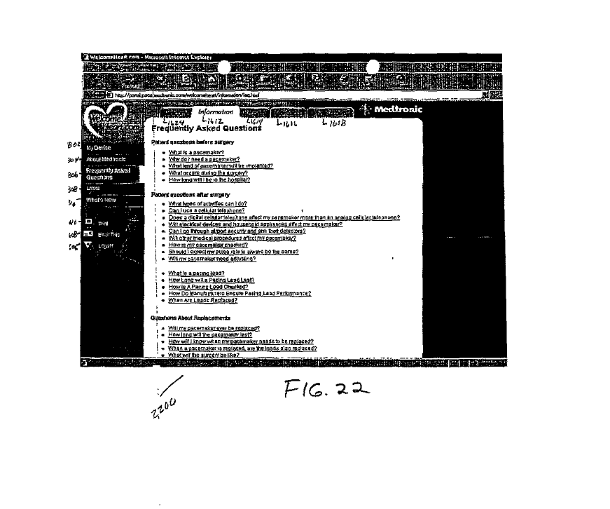

With reference to FIGS. 20 and 21, if the patient clicks on about device manufacturer link 1804, they are linked to information about the manufacturer as stored in server file 2000 (step 410 FIG. 4). The manufacturer information server file 2000 preferably provides a human face to the manufacturer and promotes brand and product awareness. Server file 2000 preferably discusses such topics as the manufacturer's mission statement 2002, any philanthropy by the manufacturer 2004, and history of the manufacturer 2006. All this information provides the patient with assurance to the manufacturer's quality commitment. Further, because all the information on web page 2000 can be found publicly there is no need to provide any security for the information.

All references to the manufacturer are being made to illustrate the preferred embodiment. However, any private, or public corporation, institution, or individual could be utilized for patient portal 300 within the scope of the invention.

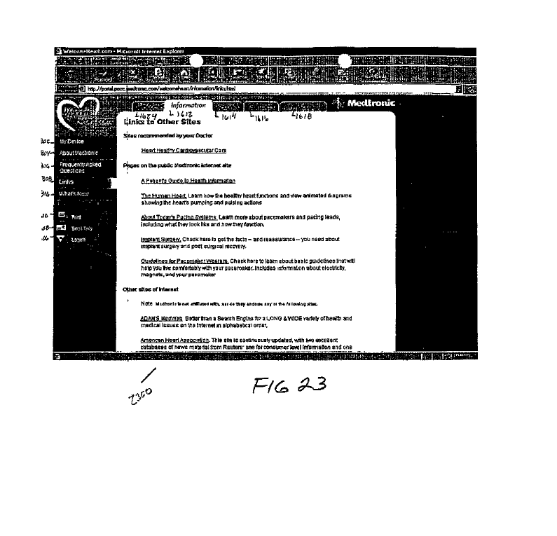

With reference to FIG. 22, if the patient executes frequently asked questions link 1806, they are linked to frequently asked questions web page 2200 (step 412 FIG. 4). Frequently asked questions interface 2200 preferably is designed to provide reassurance to patients, make them more informed medical device consumers, and reduce the burden of answering questions for clinicians and Medtronic patient support groups. Interface 2200 is customized by the type of devices the patient has implanted, the types of frequent questions previously viewed by the patient, and frequently asked questions by clinicians. Because interface 2200 does not have any sensitive information there are limited security concerns.

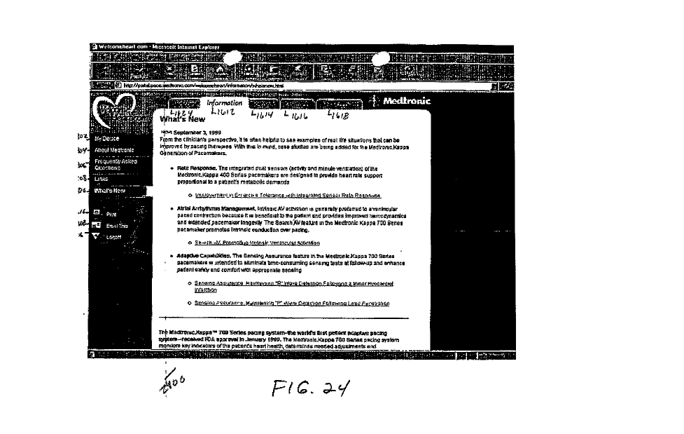

With reference to FIG. 23, if the patient executes links link 1808, they may be linked to a links server file embodied in interface 2300 (step 414 FIG. 4). Links interface 2300 provides a plurality of web links to related medical sites. Interface 2300 is customized by the type of devices the patient has implanted, recommended links provided by the patient's physician, and access restrictions recommended by the patient's physician. Because interface 2300 contains information that is publicly available, there are limited security concerns.

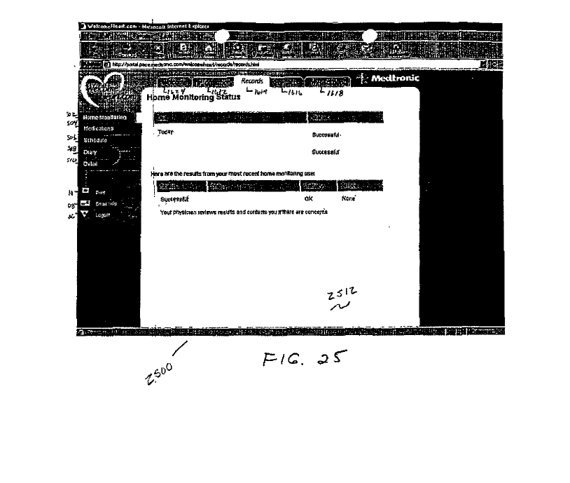

With reference to FIG. 24, if the patient executes what's new link 1810, they are linked to what's new server file 2400 (step 416 FIG. 4). Interface 2400 provides the latest information pertinent specifically to the patient's device and disease state. It preferably provides a forum to re-enforce a manufacturer's commitment to innovation and quality, and a place for patients to read about the latest research on their disease. The type of devices the patient has implanted, access restrictions recommended by the patient's physician, customizes interface 2400 and marketing-controlled information such as new product releases. Because interface 2400 contains information that is publicly available, there are limited security concerns.

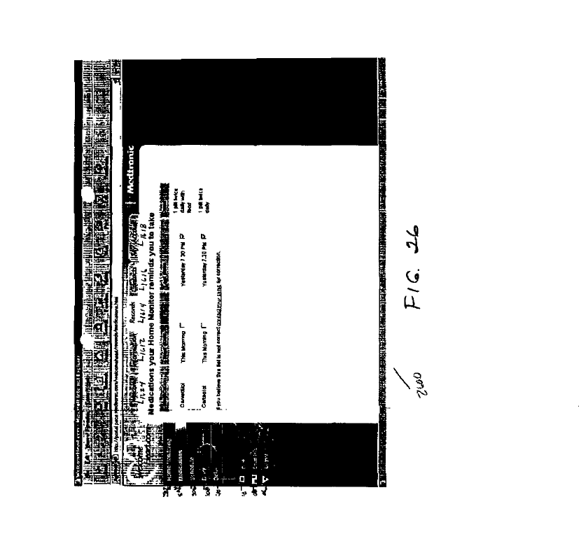

With respect to FIG. 5, records server architecture diagram 500 is shown. After clicking on records link 1614 the patient is linked to records server file embodied in interface 2500 (step 322 FIG. 3). With respect to FIG. 25, records interface 2500 offers more web links including, for example, Home monitoring link 2502; Medications link 2504; Schedule link 2506; Diary link 2508; Detail link 2510.

Steps 502, 504, and 506 are substantially the same as steps 314, 316, and 318 respectively and therefore reference may be made to the operation of links 1606-1610 discussed above. Further, links 1612, 1614, 1616, 1618, and 1624 function substantially the same on records interface 2500 as they did on welcome interface 1600.

When the patient first arrives at records interface 2500, home monitoring interface 2512 is displayed (step 508 FIG. 5). Interface 2512 allows the patient to view whether monitoring sessions were successful or to troubleshoot errors when they occur. The patient thus gains reassurance by viewing very high-level or general results of monitoring transmissions. This reduces the burden of phone calls by clinicians. Interface 2512 may be customized by whether the patient has home monitoring, the results of home monitoring sessions, the type of implanted device and home monitor the patient has, and access restrictions controlled by the patient's physician. Because home-monitoring results may contain private data, all data on interface 2512 will preferably be encrypted and strong authentication will be required. Any type of encryption known to those skilled in the art may be used.

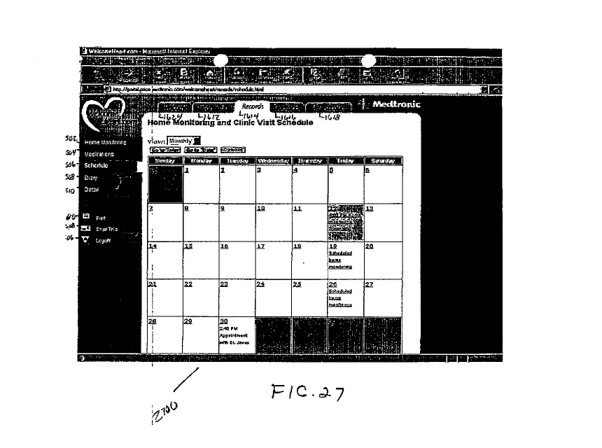

With reference to FIG. 26, if the patient clicks on medications link 2504, they may be directed to medications interface 2600 (step 510 FIG. 5). Medications interface 2600 gives a detailed listing of what medication the patient is supposed to take and if the patient has taken the medication. Interface 2600 will help increase patient medication compliance by providing a place to organize a patient's medication and dosage regimes that automatically is the same as their clinic chart, providing reminders on the web to take medications, and providing a control point for home monitor-based medication compliance tools. Not only does interface 2600 address the problem of patient compliance, interface 2600 reduces the time spent organizing and reconciling medication lists for both patients and physicians. Medications interface 2600 may be customized by the medications and dosages prescribed by their physician, the medications and dosages entered by the patients, reminders enabled by physicians for some or all patients, compliance inputs from the home monitor, and inputs from pharmacy or clinic charting systems. Medication data is naturally considered private data and therefore will preferably require encryption and strong authentication at login.

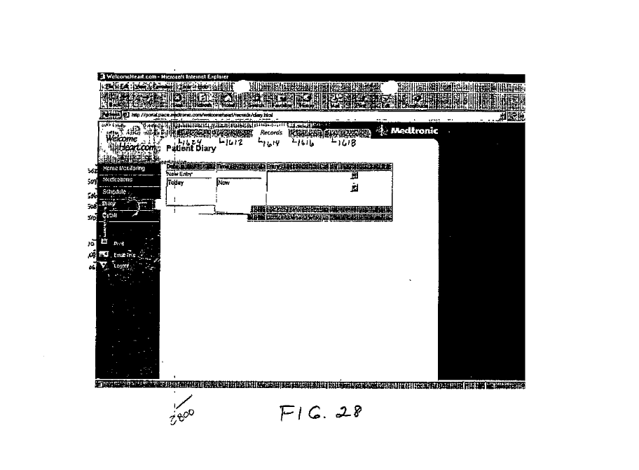

With reference to FIG. 27, if the patient executes schedule link 2506, they may be linked to schedule interface 2700 (step 512 FIG. 5). Schedule interface 2700 may provide an automated means for scheduling home monitoring sessions. Therefore, home monitoring can be deployed without additional burden on clinic scheduling staff. Physicians can enter their prescribed follow-up intervals, and then the system can schedule the follow-up days. Patients can customize their schedule without contacting the clinical staff. Scheduling interface 2700 preferably will be integrated with the clinic's in-office scheduling, e.g., by means of a CGI binary executable enabling doctor's appointments to be made online. Prescribed follow-up intervals, missed follow-ups, patient made appointments, and clinic in-office appointment schedules preferably customize the information contained on interface 2700. Schedule interface 2700 information would be considered patient private data and would therefore call for encryption and strong authentication.

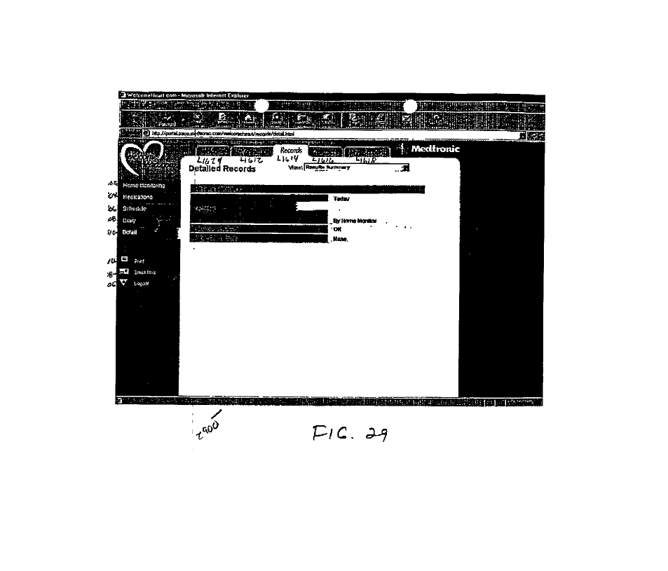

With reference to FIG. 28, if the patient executes diary link 2508, they may be directed to linked to diary interface 2800 (step 514 FIG. 5). Diary interface 2800 provides an environment where the patient's daily medical journal entries can be captured. Voice or text can be captured either on diary interface 2800 or potentially on a home monitor. Regardless of where the information is entered, diary interface 2800 will preferably provide a utility to review and edit the information. Further, interface 2800 preferably does not need further transcription or transfers to become part of a medical chart, e.g., via a CGI binary form. By putting interface 2800 on a common network, all information entered via interface 2800 becomes immediately available to all medical caregivers. Diary interface 2800 is preferably customized by whether the patient's physician advises use of a diary for their condition, whether the patient uses their home monitor to capture diary entries, and the types of events they should capture entries for, which may in turn depend directly on their devices and disease state. Because diary interface 2800 is private patient data it calls for encryption and strong authentication.

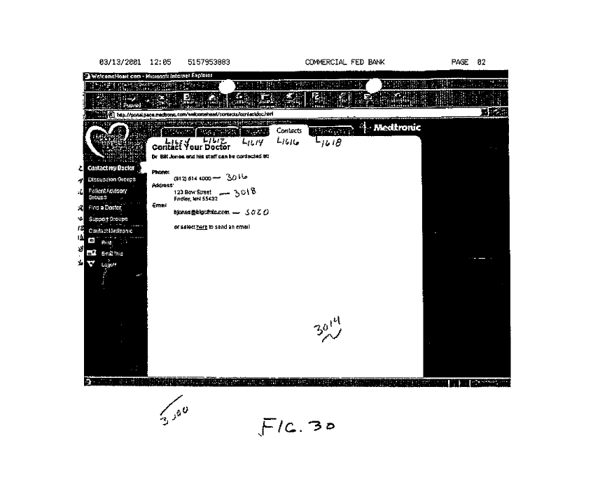

With reference to FIG. 29, if the patient executes detail link 2510, they may be directed to detail interface 2900 (step 516 FIG. 5). Detail interface 2900 contains detailed device data and patient records and makes them available for some patients depending on whether the physician allows the patient to observe the information. The information on interface 2900 is customized by whether the patient's physician enables the patient to observe the information on interface 2900 and to what extent, the type of implanted device, and the services the physician receives (e.g., do they have dictation or clinical database interfaces).

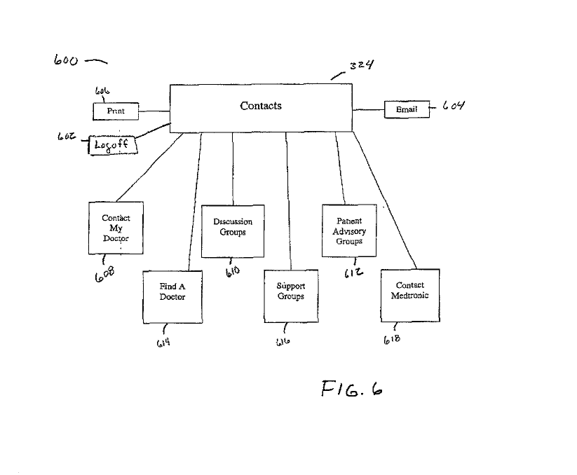

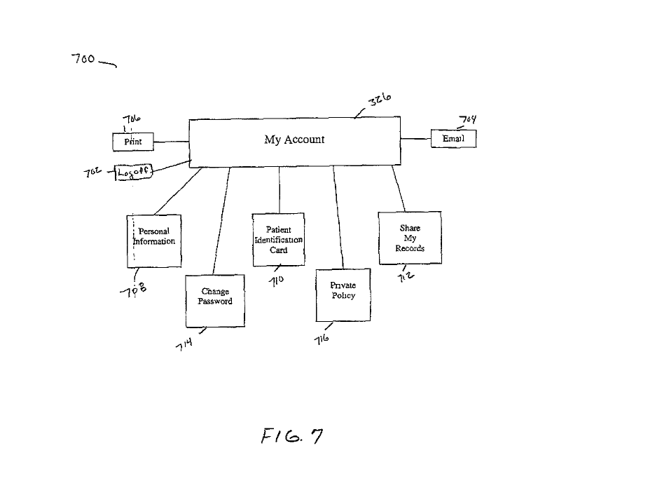

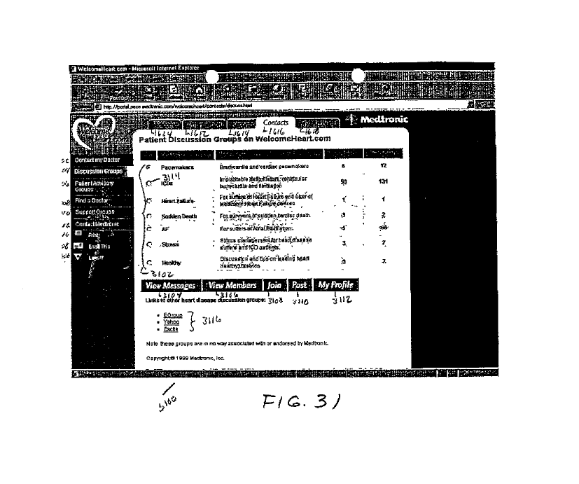

With respect to FIG. 6, contacts interface architecture diagram 600 is shown. After accessing contacts link 1616 the patient may be directed to contacts web page 3000 (step 324). With respect to FIG. 30, contact web page 3000 offers more server file or network links including Contact my Doctor link 3002; Discussion Groups link 3004; Patient Advisory Groups link 3006; Find a Doctor link 3008; Support Groups link 3010; and Contact device manufacturer link 3012.

Steps 602, 604, and 606 are substantially the same as steps 314, 316, and 318 respectively and therefore reference may be made to the operation of links 1606-1610 discussed above. Further, links 1612, 1614, 1616, 1618, and 1624 function substantially the same on contacts interface 3000 as they did on welcome interface 1600.

When the patient first arrives at contacts web page 3000, “contact your doctor” interface 3014 may be displayed (step 608 FIG. 6). The “Contact your doctor: interface 3014 preferably displays contact information for every physician assigned or associated with the patient. Interface 3014 may display, e.g., a phone number 3016, an address 3018, or an email address 3020. Further, email address 3018 allows the patient to click on address 3018 and email their physician directly from interface 3014 or by means of a local SMTP utility. Because information on interface 3014 may be publicly available, no encryption is necessary, however, if the physician decides to provide the patient with a private phone number, address, or email address then encryption and strong authentication can be provided for interface 3014.

With reference to FIG. 31, if the patient executes discussion groups link 3004, they may be directed to discussion groups interface 3100 (step 610 FIG. 6). Interface 3100 allows the patient to choose from a listing 3102 of discussion groups which may be implemented, e.g., in Usenet fashion. The discussion groups may be customized to the patient based upon what medical devices are implanted in the patient and what diseases the patient is afflicted with. Interface 3100 allows the patient to, for example, View messages in the discussion group by clicking on view messages button 3104 and linking to a web site that displays a discussion of the selected discussion group; View members in the discussion group by clicking on view members button 3106 and linking to a web site that displays all of the members currently in the selected discussion group; Join the discussion group by clicking on join button 3108 and linking to a web site that allows the patient to join the selected discussion group; Make a posting by clicking on post button 3110 and linking to a web site that allows the patient to post a message on the selected discussion group; and View the patient's profile by clicking on profile button 3112 and linking to a web site that allows the patient to view information about them that is displayed to other members of the selected discussion group.

To select a discussion the patient may access any of radio buttons 3114 in front of the desired respective discussion group. After a discussion group is selected then the patient can actively participate in a discussion by utilizing button icons 3104-3112. The patient also preferably has the ability to link to other related discussion groups on unrelated web pages 3116, including but not limited to, Excite, Yahoo, and group. Because discussion group information is not considered private there are limited security concerns and encryption is typically not necessary.

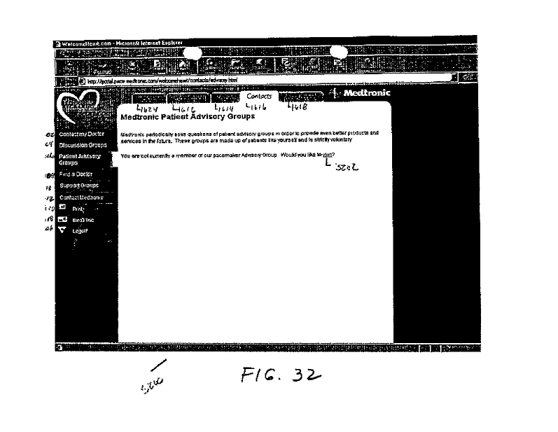

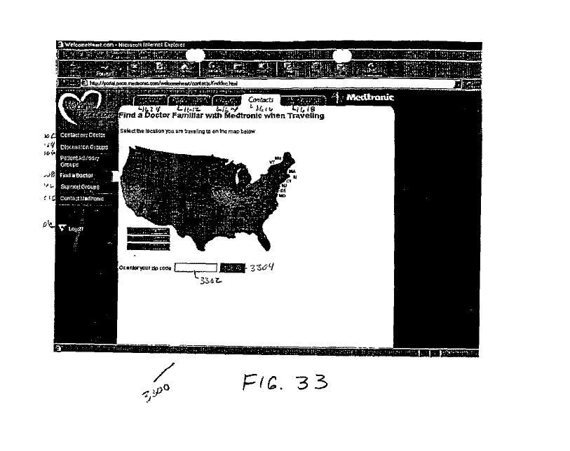

With reference to FIG. 32, if the patient executes patient advisory groups link 3006, they are linked to patient advisory groups interface 3200 (step 612 FIG. 6). Interface 3200 allows the patient to participate in patient advisory groups, which may periodically be polled in order to aid in the development of improved products and services. The patient may be allowed to join the patient advisory group by clicking on a join link icon 3202. After accessing link icon 3202, the patient is linked to a registration interface so that the patient may participate in the patient advisory group.

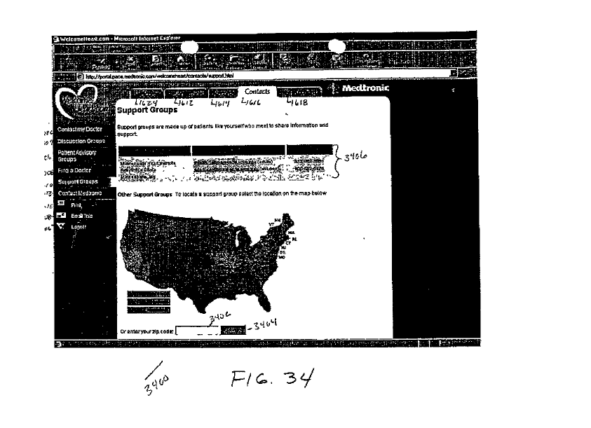

With reference to FIG. 33, if the patient executes “find a doctor” link 3008, they are linked to “find a doctor” interface 3300 (step 614 FIG. 6). Interface 3300 allows the patient to find a doctor, preferably one that is familiar with the device the patient has implanted. The patient may input something specific to the location, e.g., a zip code or a telephone area code into a CGI binary form. For purposes of the preferred embodiment the user inputs a zip code of a desired location in zip code box 3302 and then executes locator button 3304. The user may then be linked to a web page giving contact information for all physicians familiar with the patient's implanted device in the chosen geographic area. Interface 3300 may assure the patient that regardless of where they travel globally there will be a physician familiar with their implanted device in case of an emergency or any other need.

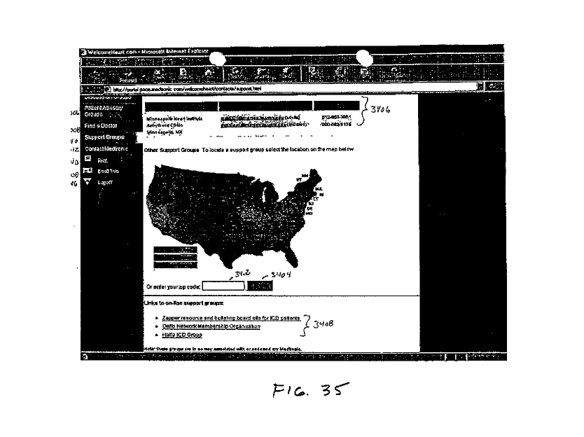

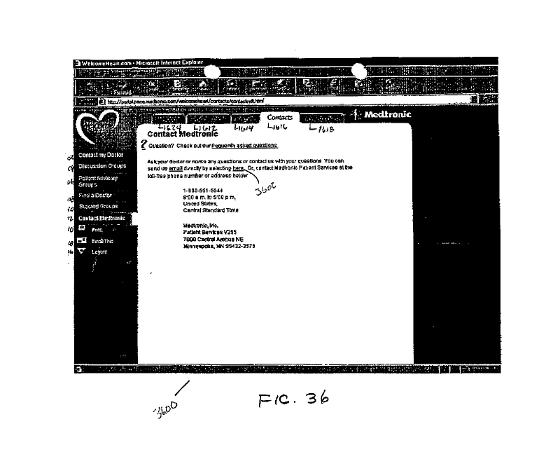

With reference to FIGS. 34 and 35, if the patient executes support groups link 3010, they may be linked to support groups interface 3400 (step 616 FIG. 6). Interface 3400 allows the user, similar to “find a doctor” interface 3300, find support groups associated with either the implanted device the patient has or the disease the patient is afflicted with. For purposes of the preferred embodiment the user inputs a zip code of a desired location in zip code box 3402 and then executes locator button 3404. The user is then shown a display 3406 of all relevant support groups and their contact information. Display 3406 is customized based upon the device the patient has implanted and the disease the patient is afflicted with. Further, there are more links 3408 of other unassociated support groups located at the bottom of page 3400. Page 3400 typically will not need encryption because of the public nature of the information content.

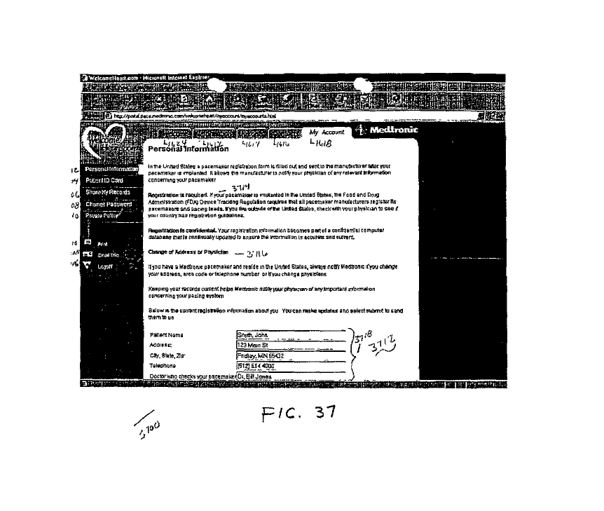

With reference to FIG. 36, if the patient executes contact device manufacturer link 3012, they are linked to a “contact manufacturer” interface 3600 (step 618 FIG. 6). Interface 3600 allows the patient to directly contact the device manufacturer, or administrator of the server. Page 3600 allows the patient to call, write or email the manufacturer with any questions or comments. Further, there is a direct email link 3602 that will link the patient to email software such as an SMTP utility resident on the local machine. Once again, because all information on page 3600 is public there is typically no need for data encryption.

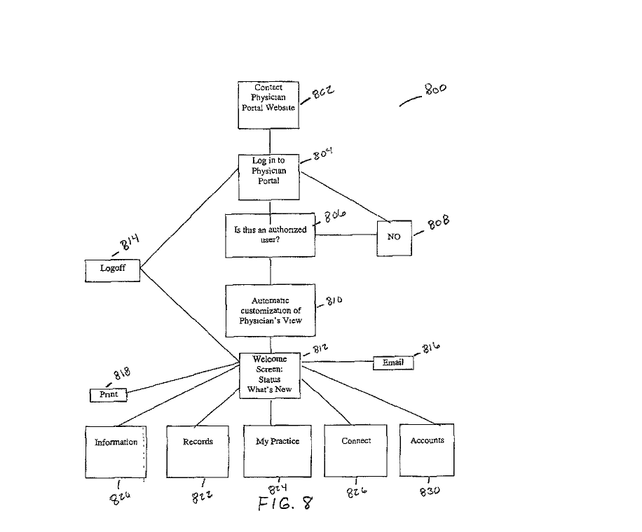

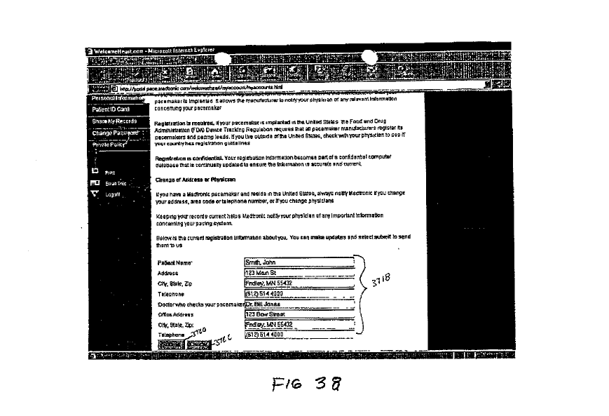

With respect to FIG. 7, a “my account” interface architecture diagram 700 is shown. After executing “my account” link 1618, the patient is linked to “my account” interface 3700 (step 326). With respect to FIG. 37, contact interface 3700 offers more network or server links including Personal Information link 3702; Patient ID card link 3704; Share my records link 3706; Change password link 3708; and Private policy link 3710.

Steps 702, 704, and 706 are substantially the same as steps 314, 316, and 318 respectively and therefore reference may be made to the operation of links 1606-1610 discussed above. Further, links 1612, 1614, 1616, 1618, and 1624 function substantially the same on the “my account” interface 3700 as they did on welcome interface 1600.

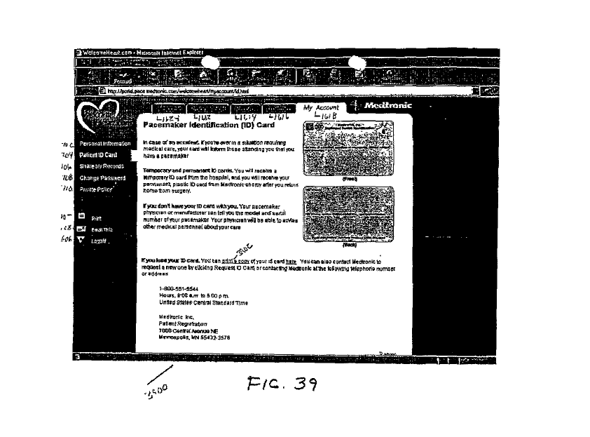

With reference to FIGS. 37 and 38, when the patient first arrives at my account interface 3700, personal information interface 3712 is displayed (step 708 FIG. 6). Interface 3712 provides the patient with information customized to the type of device the patient has implanted and the disease the patient is afflicted with. Such information may include, but is not limited to, registration information for an implanted device 3714 and change of address information for the patient's physician 3716. The patient can change their physician information simply by inputting the appropriate information in physician information boxes 3718 and then executing submit button icon 3720. If any information is enter incorrectly then the patient executes cancel button 3722. Page 3700 contains public information so generally no encryption is necessary.

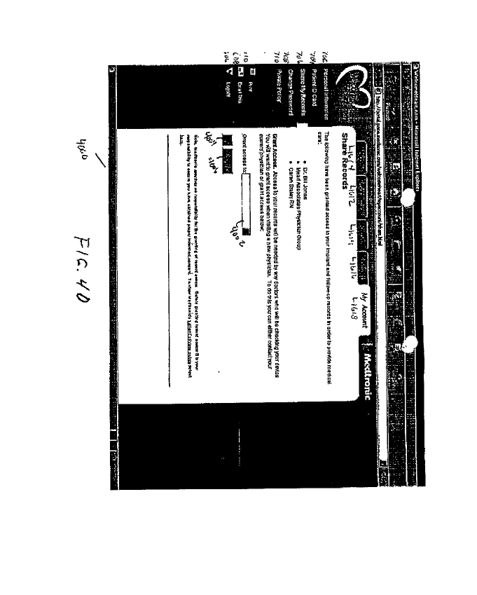

With reference to FIG. 39, if the patient executes patient ID card link 3704, they are linked to patient ID card interface 3900 (step 710 FIG. 7). Page 3900 provides the patient with important information including, but not limited to The importance of medical device identification cards for physicians in the event of an accident or hospitalization; Notification that the patient should have a temporary and permanent ID card; Notification of what to do when to do when the patient doesn't have an identification card on them; and How to print a copy of the patients ID card to keep as a temporary card until a permanent card can be issued.

The patient may also be supplied with contact information so that the patient can request an ID card. If a patient desires to print a temporary ID card then they may execute “print a copy” icon 3902. Icon 3902 initiates the printing of a temporary ID card at the local (patient) machine.

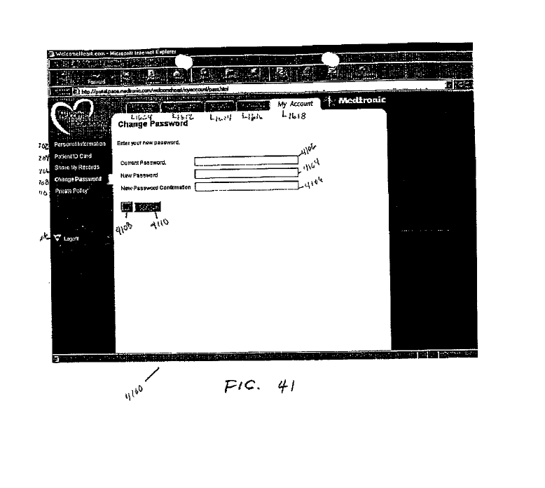

With reference to FIG. 40, if the patient executes “share my records” link 3704, they are linked to “share my records” interface 4000 (step 712 FIG. 7). Page 4000 displays to the patient all the persons or organizations that have been granted access to implant and follow-up records. Thus a patient can grant access to a new physician before even visiting the physician. By inputting the physician's or organization's name in access box 4002 and clicking on submit button 4004 the website owner is notified that the patient is granting consent for that individual or organization to have access to implant and follow-up records. Further, if the patient decides not to grant access then they can execute cancel button icon 4006. Preferably, this embodiment of the present invention will provide for digital signature authentication, or a blanket waiver on file featuring a written signature, to ensure that medical information disclosure has been authorized by the patient.

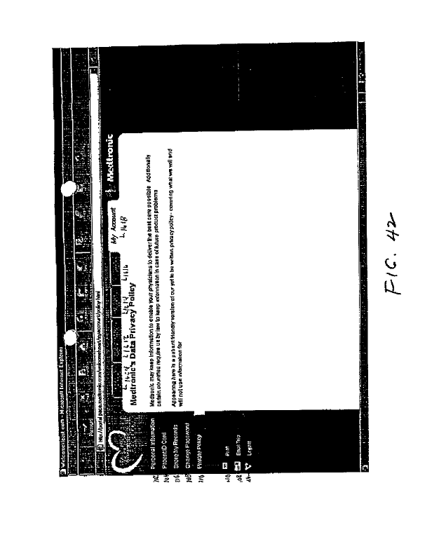

With reference to FIG. 41, if the patient executes change password link 3708, they are linked to a change password interface 4100 (step 714 FIG. 7). Page 4100 allows the patient to change their password. The patient first inputs their current password in current password box 4102. Next the patient enters the new password in new password box 4104. Now the patient enters the new password once again to assure the patient knows the password in new password confirmation box 4106. When the patient is finished they execute submit icon 4110. If the patient decides to not to change their password they can execute cancel icon 4108.

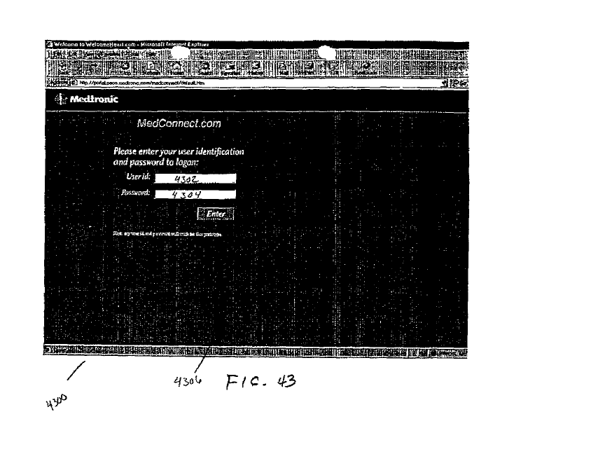

With reference to FIG. 42, if the patient executes private policy link 3710, they are linked to private policy interface 4200 (step 716 FIG. 7). Page 4200 provides the patient with notification of the web site's privacy policy concerning what the patient's personal information will and will not be used for and under what conditions information will be disclosed.

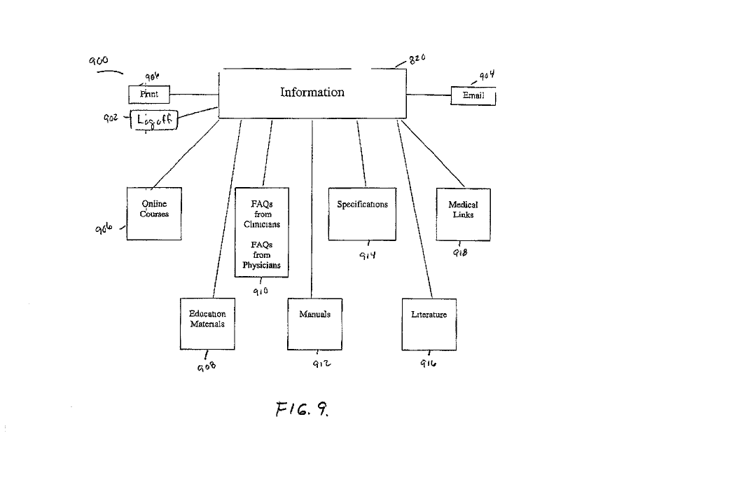

With reference to FIG. 8, patient/physician portal 800 may be implemented as a secure web site for a physician or technician monitoring a patient implanted with a medical device. The medical device can be any of that known in the art, including but not limited to, such devices as a defibrillator or a pacer, a neural implant, or a drug pump. Physician portal 800 provides personalization, automatically providing only information pertinent to the physician, and preferably to a specific patient's device and disease. Because portal 800 contains personal information specific to the patient, access to portal 800 requires secure access. It should be noted that patient/physician portal 800 is substantially the same as patient/physician portal 300 except that the physician is allowed to view more information. In addition, the interface is structured somewhat differently based on the goals desired to be achieved with the portal. Therefore, while the overall structures between portals 800 and 300 are essentially the same, the content of both will preferably be different and thus are discussed separately herein.

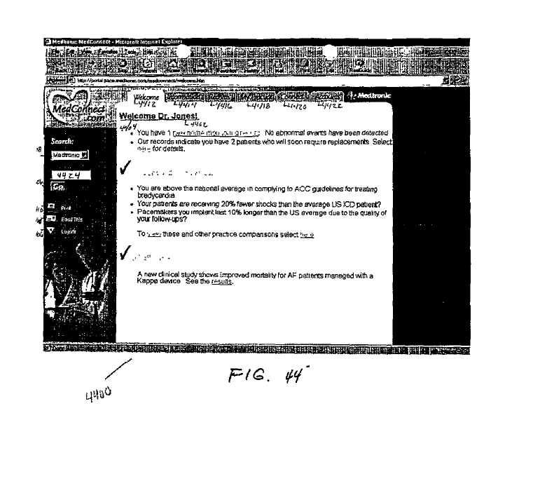

With further reference to FIG. 8, an architecture diagram of patient/physical portal 800 is depicted, detailing a typical physician session. Prior to the start of a physician session, a physician contacts the patient/physician portal interface in one of a manner of data communications methods as discussed above with reference to a patient access session (step 802). The physician may, for example, contact patient/physician portal interface 800 through a web browser by entering a patient/physician portal URL. The physician has the option to go directly to the patient/physician portal interface where he or she can then link to login interface 4300 (FIG. 43), or the physician can directly input portal login interface 4300 network or server location, and go directly to patient portal login interface 4300.

Regardless of how the physician arrives at patient/physician portal login interface 4300, once connected to patient/physician portal 800 the patient may then log into patient/physician portal 800 (step 804) at login interface 4300. Login interface 4300 allows access to patient/physician portal 800 when the physician may enter a user id and password specific to the physician or technician. Since login page 4300 accepts user ids and passwords, interface 4300 is preferably encrypted to ensure secure transmission of the entered passwords. In an Internet embodiment of the present invention, interface 4300 can be accessed by anyone; therefore, it will preferably contain minimal content to further ensure security. In addition, interface 4300 will accommodate both strong and weak authentication. A physician login using weak authentication will have access to mildly secure features, while those with a strong login can view all content. Therefore, the amount of content viewed by the user will be determined by who the user is and the strength of authentication.

At login interface 4300, the physician may enter a user id specific to the physician in user id box 4302. The physician may also enter a password specific to the physician in password box 4304. If the user id and password identify the user as a physician then they are granted access to portal 800, and if the user id and password identify the user as a patient then they are granted access to portal 300. When the physician has inputted a user id and password, the physician then may execute enter button 4306 or the user can also press the return button on the keyboard to input their user id and password. With reference to FIG. 8, the physician portal server must determine if the physician has properly inputted the correct user id and password (step 806). If the user has improperly inputted either the user id or the password (step 808) then the user is directed back to login interface 4300 where the physician can reenter their user id and password (step 804).

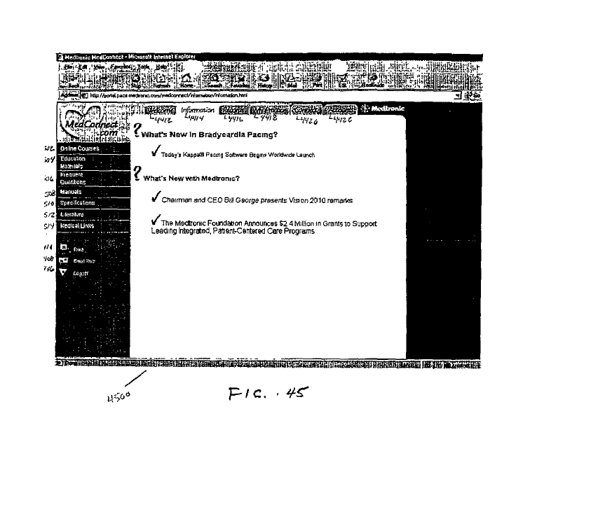

If the physician's user id and password were inputted correctly then the physician will be linked to physician welcome interface 4400 (FIG. 44) (step 812). However, before the physician or technician arrives at welcome interface 4400 the patient /physician portal interface is preferably customized (step 810) to the physician. Therefore, when the physician arrives at welcome interface 4400, physician specific information is displayed in a user-friendly manner.

With reference to FIGS. 44, welcome interface 4400 may include such features as Physician's name 4402 appearing in welcome message 4404; A listing of all patients treated by the physician with implanted devices and any relevant information concerning those devices; and Marketing preferences of what news or new products may be of interest to the physician. Information personal to the physician can be obtained through a patient registration process.

Since no physician or patient private data appears on welcome interface 4400, only weak authentication will preferably be required for a user to obtain access to welcome interface 4400.

Welcome interface 4400 offers a plurality of server or network links, which may include Logoff link 4406; Email link 4408; Print link 4410; Welcome link 4412; Information link 4414; Records link 4416; My practice link 4418; Connect link 4420; and Accounts link 4422.

Each one of links 4412-4422 transfers the physician to another server or network file that contains patient and IMD information. In a preferred embodiment, a search box 4424 is provided where the physician can input a key word or phrase, which the physician desires information on, and then click on “Go” button 4426. A search engine will then attempt to locate relevant information resident on the server based upon the key word or phrase that the physician has inputted. It should be noted the information returned from the search engine would also be limited on a security basis depending on the physician's login authentication. The search engine could also be expanded to search other relevant network areas up to and including the entire Internet. The physician can accomplish this by using scroll bar 4428 and choosing the server or network area that they would like to search.

If the physician desires to logoff, then he or she may execute logoff link icon 4406. Upon execution of logoff link 4406 the patient is linked to login interface 4300 (step 814 FIG. 8).

Email link 4408 gives the physician the ability to email to a patient or to another physician the web page content that the user is currently viewing. If the physician desires to email anyone then they may execute email link 4408 and this directs the physician to an email interface running on the server, the computer's local email utility, or any other method of email (step 816). This email function is preferably accessible for most or all of the interfaces of patient/physician portal 800.

If the physician desires to print the web page content they are viewing then they merely need to execute print link 4410 (step 816). The ability to print will be provided for most pages depending on the level of security for the web page. On some pages the print function (step 818) will print directly, on others it will invoke a printer-friendly version of the content. Regardless of the page being printed the print setup will preferably be a function of the user's computer rather than the server implementing the patient/physician portal 800.

By executing information link 4414 the physician is preferably linked to information interface 4500 (step 820 FIG. 8). By executing records link 4416 the physician may be directed to records interface 5300 (step 822 FIG. 8). By executing a “my practice” link 4418, the physician is linked to “my practice” interface 6200 (step 824 FIG. 8). By executing connect link 4420 the physician is linked to connect interface 7300 (step 826 FIG. 8). By executing accounts link 4422, the physician is preferably linked to accounts interface 7900 (step 828 FIG. 8). Each one of these interfaces is discussed in detail below. If the physician clicks on welcome link 4412, the physician is linked to welcome interface 4400 (step 812 FIG. 8).

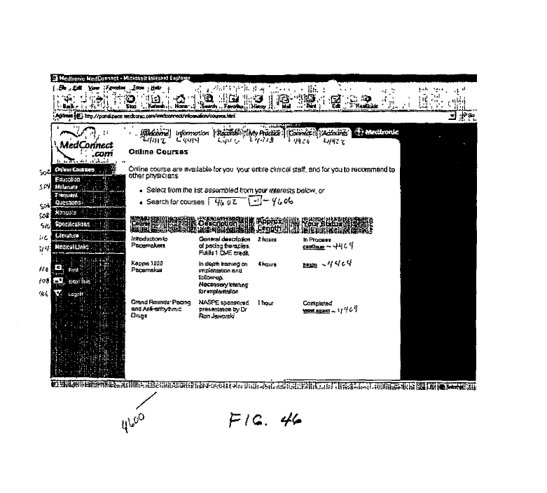

With respect to FIG. 9, information interface architecture diagram 900 is shown. After executing information link 4414, the physician is linked to information interface 4500 (step 820). With respect to FIG. 45, information interface 4500 offers more web links including Online Courses link 4502; Education materials link 4504; Frequent questions link 4506; Manuals link 4508; Specifications link 4510; Literature link 4512; and Medical links link 4514.

Steps 902, 904, and 906 are substantially the same as steps 814, 816, and 818, respectively, and therefore reference may be made to the operation of links 4406-4410 discussed above. Further, links 4412-4422 function substantially the same on information interface 4500 as they did on welcome interface 4400.

With reference to FIG. 45, when the physician first arrives at information interface 4500 (step 820 FIG. 8), the physician is preferably presented with information and new developments, including but not limited to, developments in implantable devices and new developments from implantable device manufacturers.

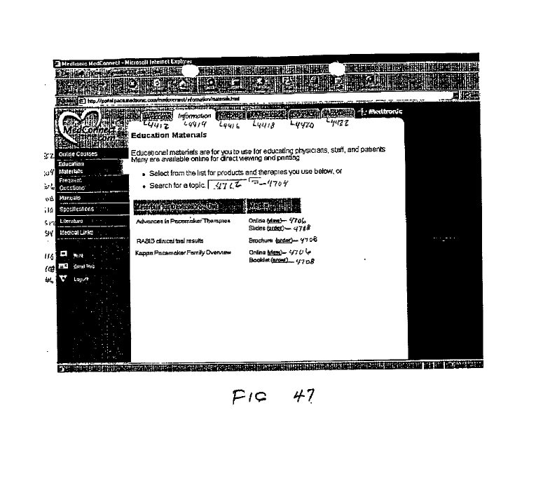

With reference to FIG. 46, by executing online courses link 4502 (step 906 FIG. 9), the physician may be linked to online courses interface 4600. Interface 4600 contains links to files and executables implementing online courses that may be available to the physician and an entire clinical staff. Interface 4600 preferably gives a detailed listing of the courses, a description of the course, the length of the course, and a status of whether the physician has viewed the course or not and how much of the course the physician has viewed. Further, the physician can search for a course by inputting a search term in search box 4602 then executing the “go” button 4606 to link to an interface, e.g., a site giving a listing of the search results. The physician can view a course by executing desired link 4604, which links the physician to a server or network file or program or implements that displays the selected course. Interface 4600 is preferably customized to the physician depending on their practice and the type of devices implanted into patients under their care.

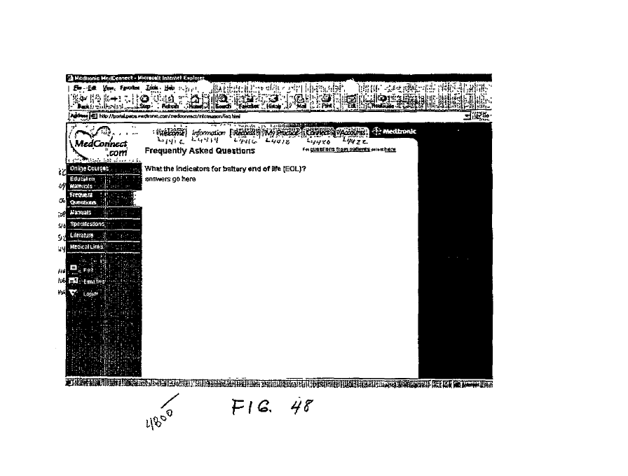

With reference to FIG. 47, by executing educational materials link 4504 (step 908 FIG. 9), the physician is linked to educational materials interface 4700. Interface 4700 contains educational materials that are available to the physician and his or her entire clinical staff. Interface age 4700 gives a detailed listing of the educational materials and listing of media that the physician can choose from in order to view the educational materials. Further, the physician can search for educational material by inputting a search term in search box 4702 then executing “go” button 4704 to link to a web site giving a listing of relevant search results. The physician can also view the educational materials by executing links 4706, which links the physician to an interface displaying the selected materials. Further, the physician can purchase hard copies of the educational materials such as brochures, slides, or books by clicking on “order” link 4708, which links the physician to an interface that facilitates the ordering process. Web interface 4700 is preferably customized to the physician depending on his or her practice and the type of devices implanted into patients under their care.

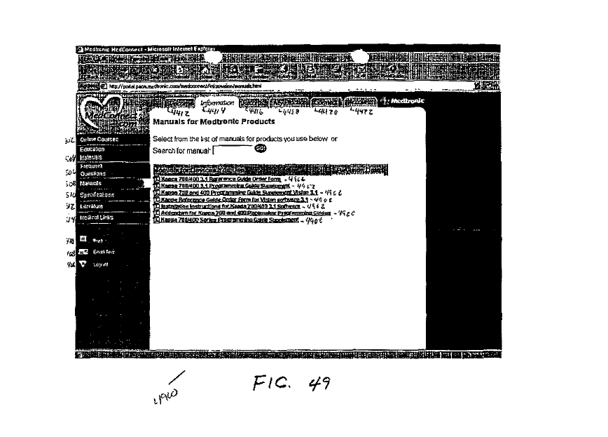

With reference to FIG. 48, if the physician executes frequently asked questions link 4506, they are linked to frequently questions interface 4800 (step 910 FIG. 9). Frequently asked questions interface 4800 provides information to physicians, which may be designed to make them more informed medical device implementers. Interface 4800 may be customized by the type of devices the physician has implanted, the types of frequently asked questions previously viewed by the physician, as well as frequently asked questions selected or submitted by the physician's patients. Because interface 4800 does not have any sensitive information typically there are limited security concerns.

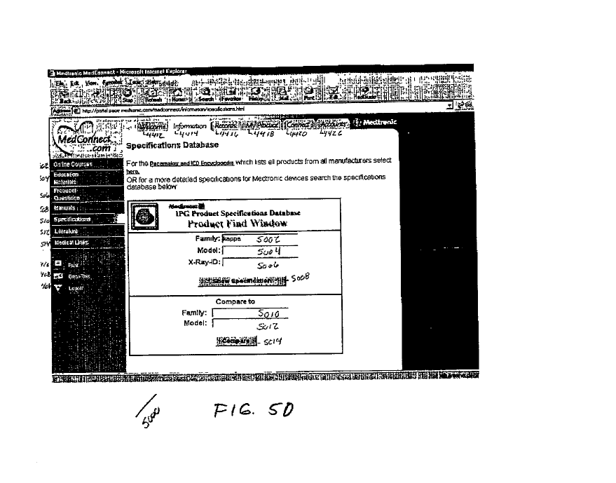

With reference to FIG. 49, by executing manuals link 4508, the physician is linked to manuals interface 4900 (step 912 FIG. 9). Interface 4900 preferably gives a listing of all or most of the manuals for the devices that the physician utilizes or has implemented, together with a listing of the last date of revision for the manual. Each manual has a link or server or network directory or location 4902, which links the physician to an interface displaying the selected manual, downloads a file in PDF format to be displayed on an acrobat reader, or implements any other method of viewing known to those skilled in the art. Further, the physician can search for a device manual by inserting a search term in search box 4904 and executing the “go” button icon 4906, which links the physician to an interface where the search results may be listed by relevance.

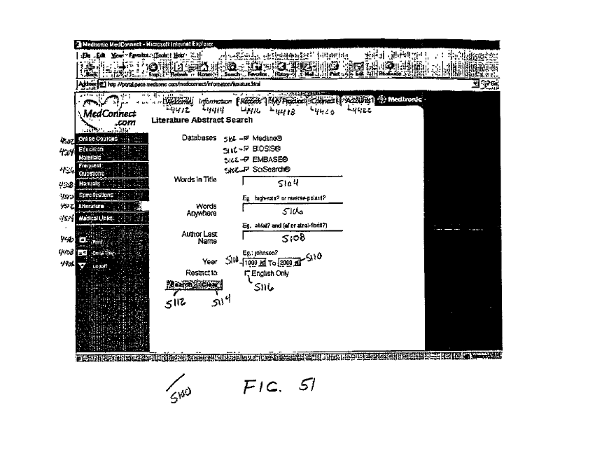

With reference to FIG. 50, by executing specifications link 4510, the physician is linked to specifications interface 5000 (step 914 FIG. 9). Interface 5000 allows the physician to obtain implanted device specification data. The physician can obtain this information by inputting either a family number or a model number, and if necessary, an X-ray ID number. The physician may input a family number in family number box 5002, or a model number in model number box 5004, and if necessary an X-ray ID in ID box 5006. After the respective device information is inserted into the applicable form boxes, the physician then executes “show specification” button icon 5008 to link to a server or network file displaying the device specification, or an interface that allows for a file download of the specification. Further, the physician can compare a device to any similar competitive or similar devices by entering the family number in family number box 5010 or a model number in model number box 5012. The physician may then execute “compare” button icon 5014 which will link the physician to an interface or displaying information file comparing a competitor's product with a product sold by the portal administrator.

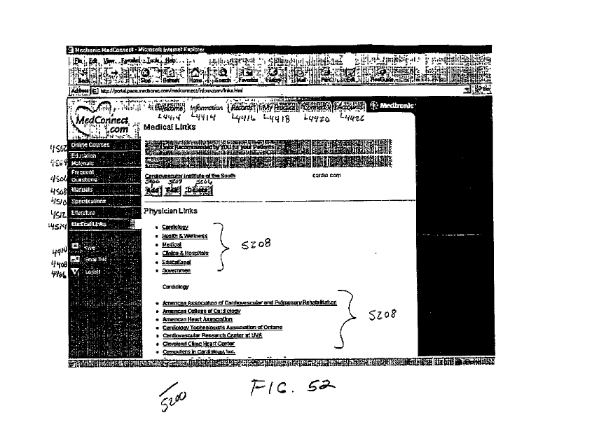

With respect to FIG. 51, by executing literature link 4512, the physician may be linked to literature interface 5100 (step 916 FIG. 9). Interface 5100 allows the physician to search for literature abstracts on a wide variety of information. The physician first may choose the databases that the physician wants to search by executing selection box 5102 for the respective database. The physician then inputs relevant search terms in “words in title” box 5104, “words anywhere” box 5106, or “author last name” box 5108; choosing the relevant literature years with scroll bar 5110. Finally, the physician executes “search” button icon 5112 to link to an interface displaying search results based on the inputted information. The physician also has the option to clear entered search terms by executing “clear” button icon 5114. Further, the physician has the option of choosing English-only results by executing “English-only” click box 5116.

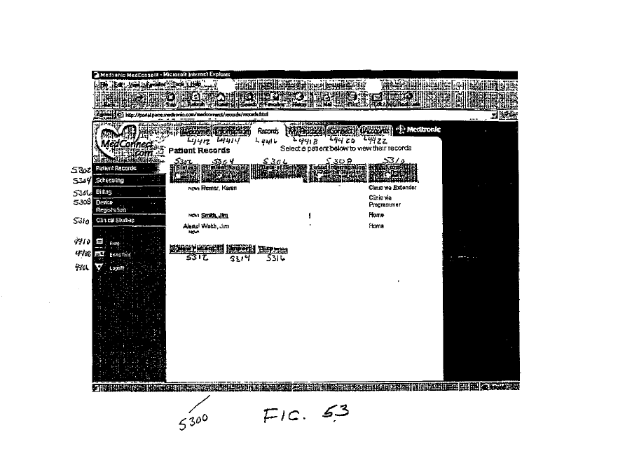

With respect to FIG. 52, by executing medical links 4514, the physician may be linked to medical links interface 5200 (step 918 FIG. 9). Page 5200 may provide a plurality of server or network links 5208, which are customized to the physician based upon the devices the physician utilizes and the patients the physician typically treats. The physician is allowed to add, edit, or delete links in his or her personal interface 5208. This can be performed by executing add button 5202, edit button 5204, or delete button 5206. For example, the add button icon 5202 links the physician to an interface where the physician can submit a web page or other file or directory on a server or network that they desire to be posted to their medical link 5200 site. The edit button 5204 may link the physician to an interface where the physician can edit a file resident on the portal server, e.g., a web page that is either already present on page 5200 or a file that the physician has submitted. The delete button 5206 allows the physician to delete any server or network link listed on medical links interface 5200.

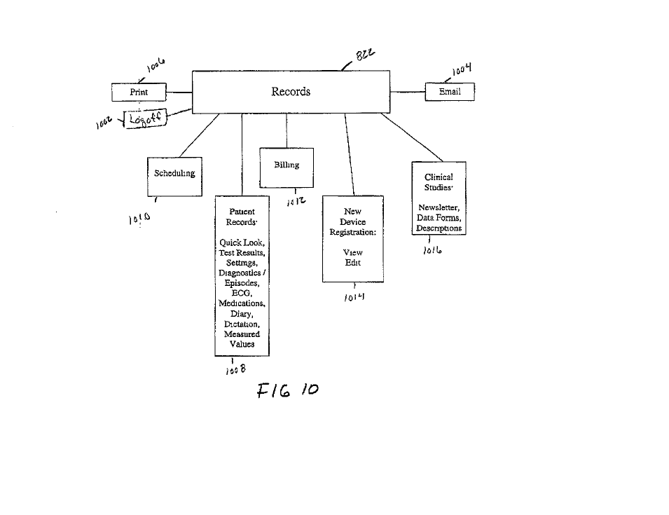

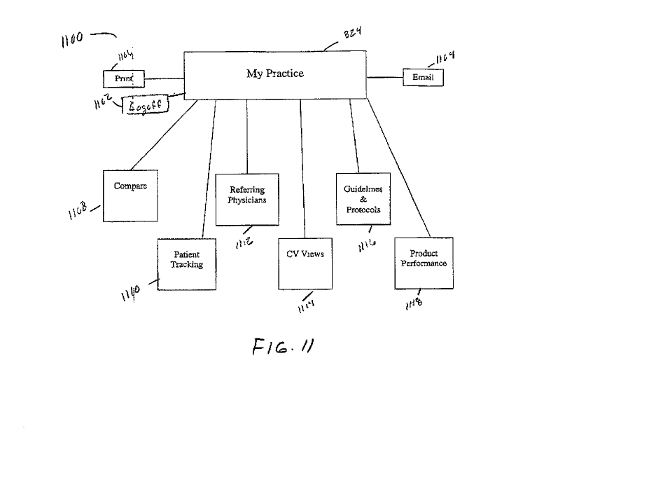

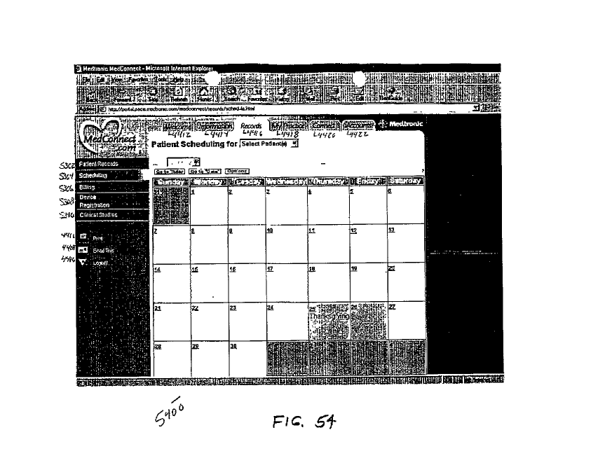

With respect to FIG. 10, records interface architecture diagram 1000 is shown. After executing records link 4416, the physician is linked to records interface 5300 (step 822). With respect to FIG. 53, records interface 5300 may offer further links to files or directories on the portal server or network, including, for example, Patient records link 5302; Scheduling link 5304; Billing link 5306; Device Registration link 5308; and Clinical Studies link 5310.

Steps 1002, 1004, and 1006 are substantially the same as steps 814, 816, and 818 respectively and therefore reference may be made to the operation of links 4406-4410 discussed above. Further, links 4412-4422 function substantially the same on records interface 5300 as they did on welcome interface 4400.

With reference to FIG. 53, by executing patient records link 5302, the physician may be linked to patient records interface 5300 (step 1008 FIG. 10). Page 5300 preferably provides information for all patients with implantable devices under the user's physicians care. Interface 5300 provides information preferably including, but not limited to, patient status, name, birth date, latest information, and where the latest information originated. Further, the information can be displayed in ascending order based on the information field that the physician considers most relevant by, for example, clicking a cursor on the relevant field heading, e.g., as depicted in FIG. 53, status radio button 5302, patient name radio button 5304, date of birth radio button 5306, latest information radio button 5308, and “interrogation source “from” radio button 5310. When the physician wants to input a new record they may click on “new patient” button icon 5312. This links the physician to an interface where all relevant patient information may be inputted, e.g., via a CGI form. The physician can also import or export an existing record by executing import button 5314 or export button 5316. These buttons allow physicians to automatically send and receive patient records.

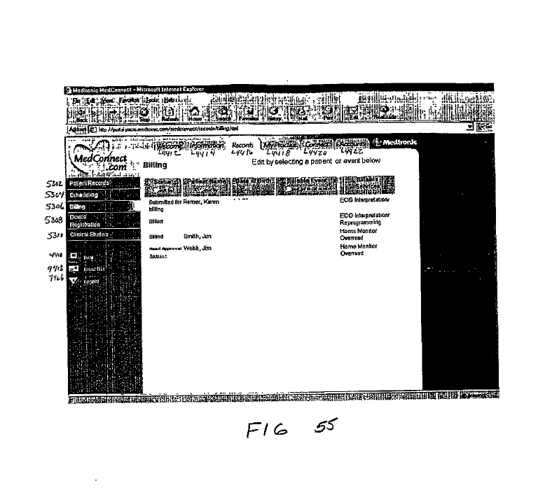

With reference to FIG. 54, by executing scheduling link 5304, the physician may be linked to patient scheduling interface 5400 or a server-based scheduling utility (step 1010 FIG. 10). Page 5400 preferably displays relevant past and future patient information including, but not limited to, patient appointments, patient monitoring events, and calibration of patient implantable devices. In a preferred embodiment, the information is displayed in a calendar format, but may alternately be viewed in other formats. The physician is also able to schedule desired appointment and monitoring events.

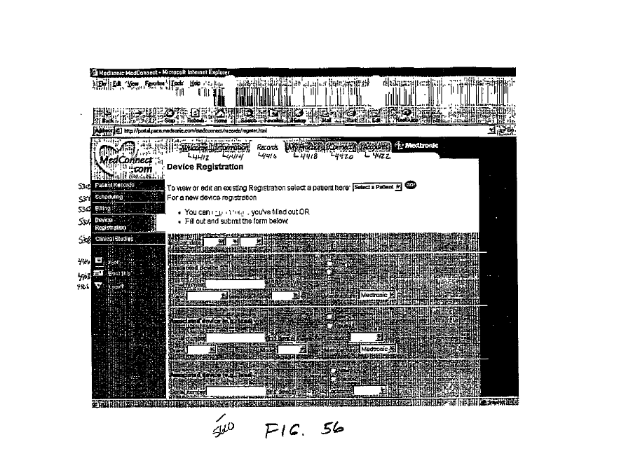

With reference to FIG. 55, by executing scheduling link 5306, the physician is linked to billing interface 5500 (step 1012 FIG. 10). Page 5500 displays billing information potentially including, but not limited to, status, patient's name, patient's date of birth, what the charge is for, diagnostic and treatment or procedure codes, and when the service was charged. Like patient record interface 5300, the information can be sorted according to the data field of interest. Because there is information personal to identifiable patients, these pages are preferably encrypted.

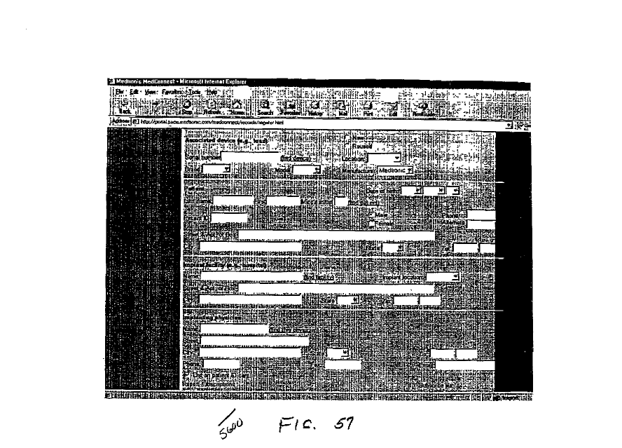

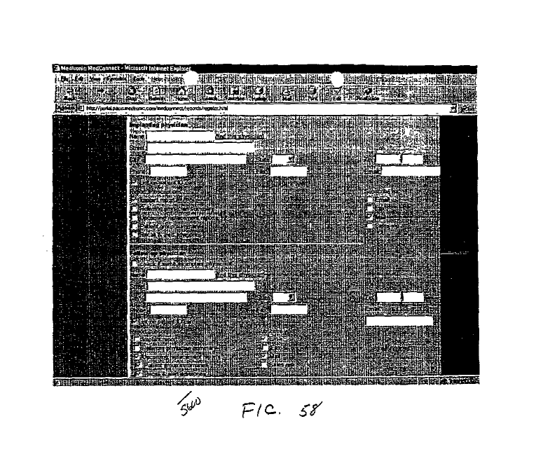

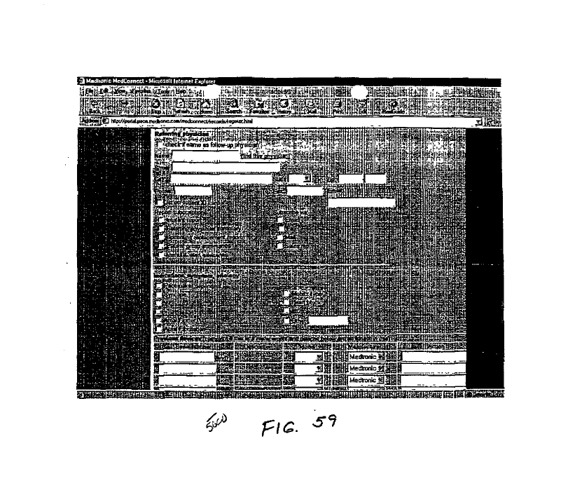

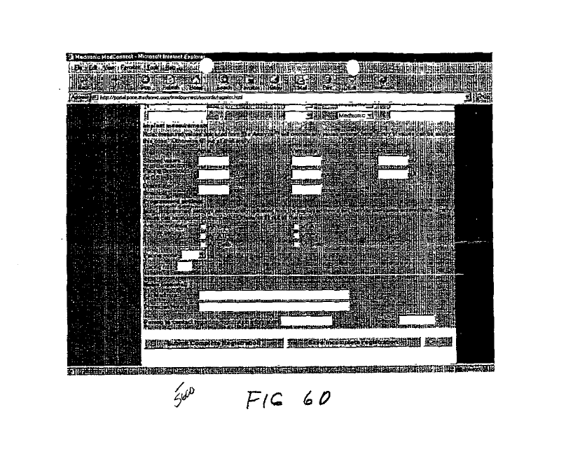

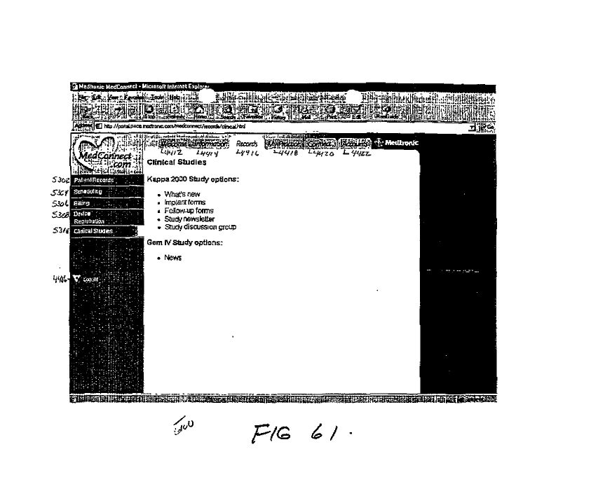

With reference to FIGS. 56-60, by executing device registration link 5306, the physician is linked to device registration interface 5600 (step 1014 FIG. 10). Page 5600 allows the physician to view or edit an existing registration, or to register a new implanted device. The physician is preferably prompted to enter information including, but not limited to, the implant date, what devices were implanted, the implant facility, the implanting physicians, the follow-up physicians, the referring physician, any indication/symptom, if the implanted device replaced an old device, any implant measurements, the programmed settings of the device, and any other important notes deemed suitable in the physician's professional judgment.

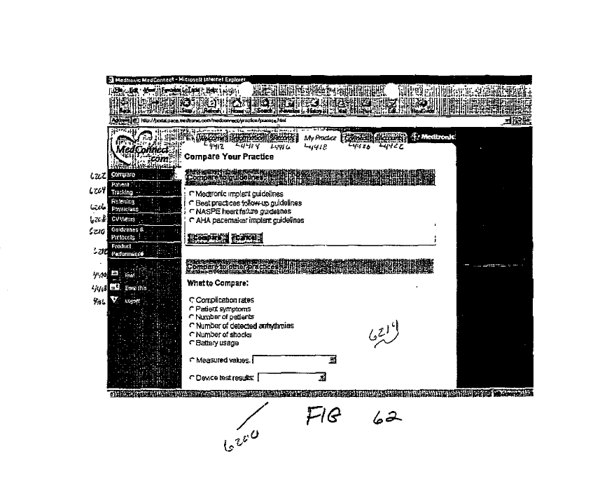

With reference to FIG. 61, by executing clinical studies link 5308, the physician is linked to clinical studies interface 6100. Interface 6100 allows the physician to examine various studies of implantable devices. Page 6100 is preferably customized to the physician based upon the implantable devices the physician uses and the patients the physician treats. The studies allow the physician to have easy access to important information concerning the devices the physician uses, and thus help the physician become more informed or maintain a level of expertise.

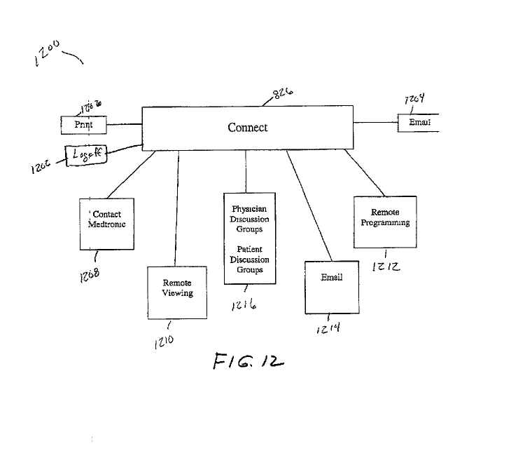

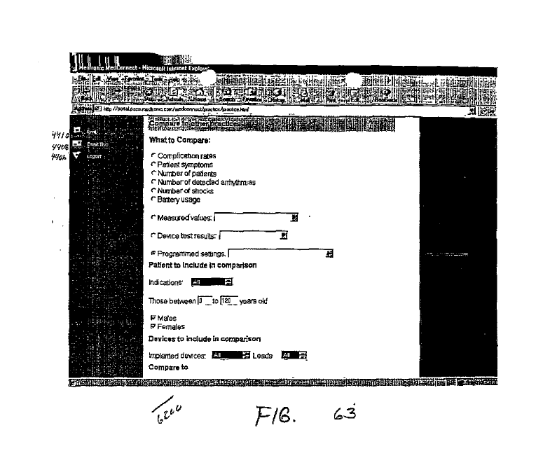

With respect to FIG. 11, a “my practice” interface architecture diagram 1100 is shown. After executing “my practice” link 4418, the physician is linked to “my practice” interface 6200 (step 824). With respect to FIG. 62, the “my practice” interface 6200 offers more file or directory links or the server of network, including Compare link 6202; Patient Tracking link 6204; Referring Physicians link 6206; CV Views link 6208; Guidelines and Protocols link 6210; and Product Performance link 6212.

Steps 1102, 1104, and 1106 are substantially the same as steps 814, 816, and 818 respectively, and therefore reference may be made to the operation of links 4406-4410 discussed above. Further, links 4412-4422 function substantially the same on the “my account” interface 6200 as they did on welcome interface 4400.

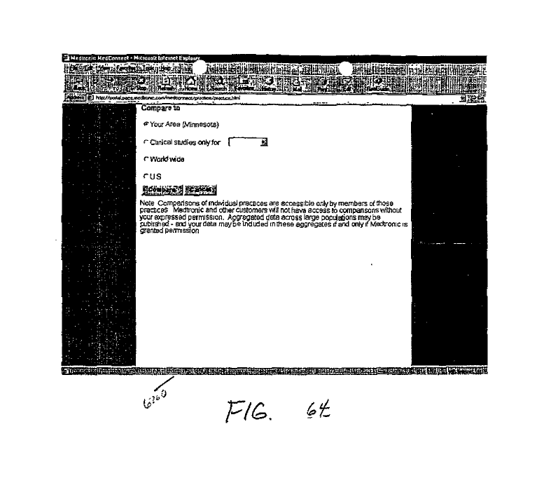

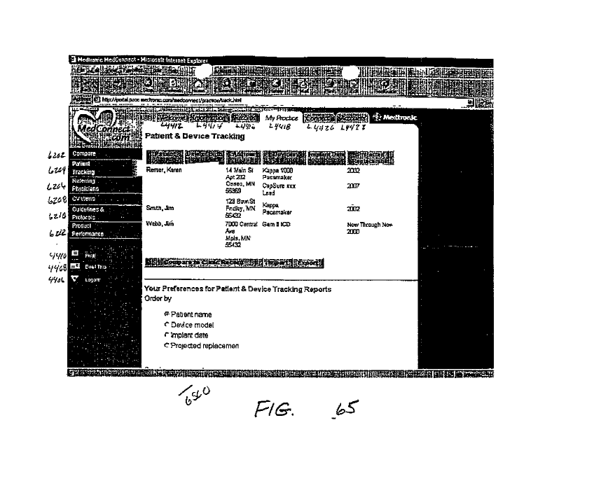

With reference to FIGS. 62-64, by executing compare link 6202, the physician is linked to a “compare” interface 6214 (step 1108 FIG. 11). Page 6200 allows the physician to compare their practice to that of other professionals and industry guidelines. The interface may preferably be customized by the information that the physician enters via the interface. The server implementing the interface may then take this information and compare the physician's performance or data against that of other practices and industry guidelines. Thus, this interface allows the physician to monitor how their practices compare against other practice and encourages the physician to improve their practice by complying with industry recommended guidelines. Preferably, this interface is implemented in a confidential manner so as to not discourage participation on the part of physicians.

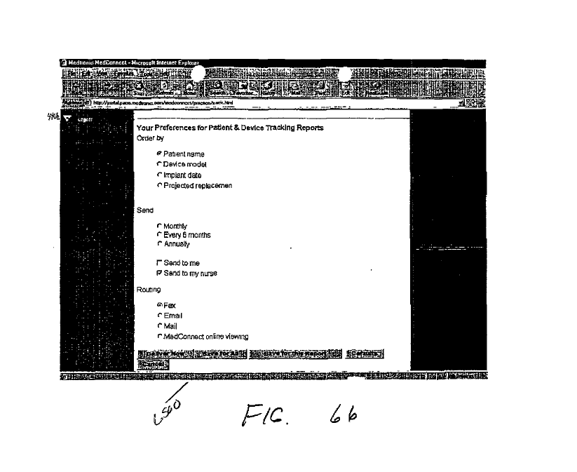

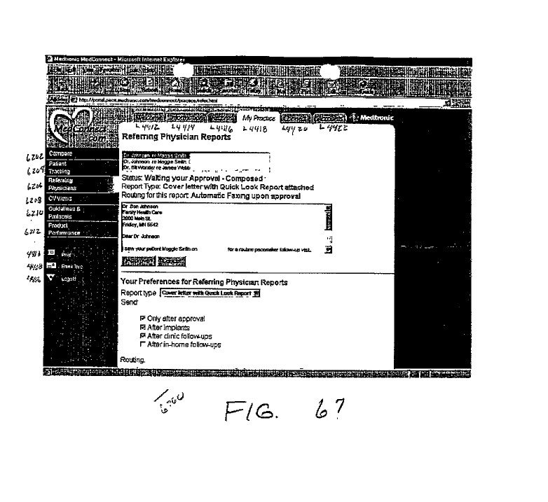

With reference to FIGS. 65-66, by executing patient tracking link 6204, the physician may be linked to patient tracking interface 6500 (step 1110 FIG. 11). Page 6500 may display all of the physician's patients, with implantable devices, and list information including, but not limited to, patient's name, patient's date of birth, patient's address, devices implanted in the patient, device serial number(s), the date of implantation, and expected device replacement date. Interface 6500 allows for the importing and exporting of information, and preferably provides a utility for the physician to compare the records to clinic records. Further, the physician may be given options to choose from as to how the patient and device tracking reports are ordered by, sent, and routed to the physician.

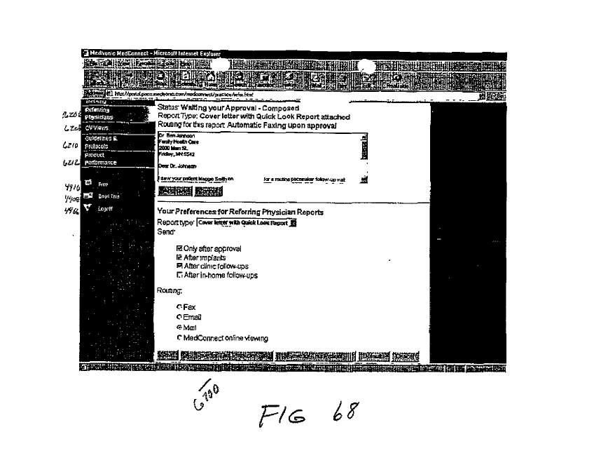

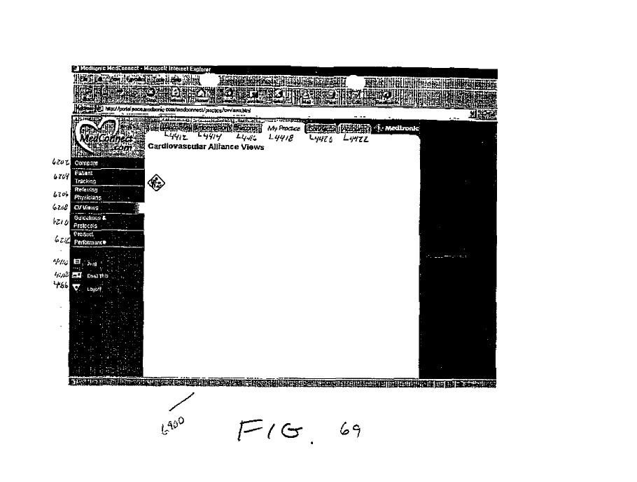

With reference to FIGS. 67-68, by executing referring physicians link 6206, the physician may be linked to a referring physicians interface 6700 (step 1112 FIG. 11). Interface 6700 allows the physician to stay in contact with other physicians which may share a common patient. Interface 6700 also provides a listing of all referring physicians; a status of a particular physician's report, what type of report is given, and when and how to send a report. There is the possibility that private patient data is included in the referring physician's reports, therefore, page 6700 will be preferably encrypted and require strong authentication at login.

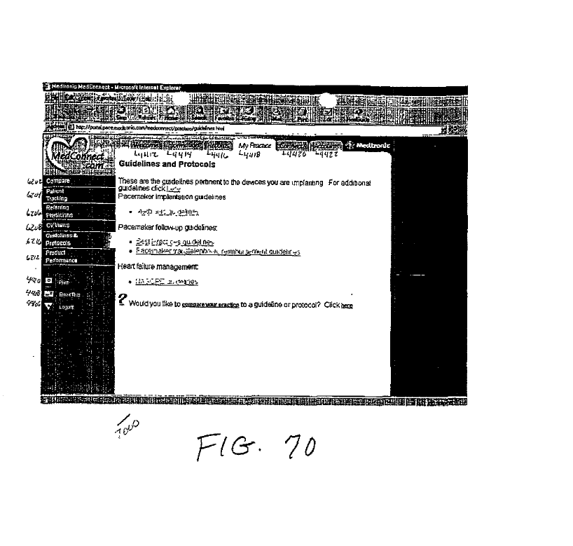

With reference to FIG. 69, by executing on cardiovascular views link 6208, the physician may be linked to a professional organization, e.g. a cardiovascular alliance views web page 6900 (step 1114 FIG. 11). Interface 6900 allows the physician to view posting and papers presented by other physicians such as those belonging to the cardiovascular alliance. The physician will be able to access papers and postings for example, by simply clicking on the title of the argument. Page 6900 enables the physician to stay abreast of important topics in the cardiovascular arena. There is no secure data on page 6900, therefore, encryption is not required.

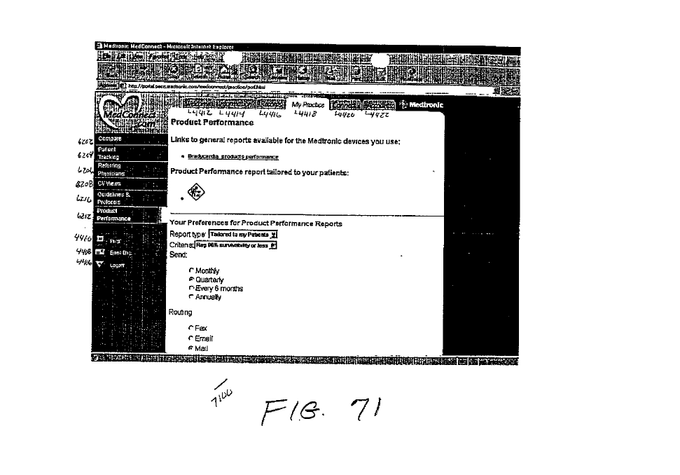

With reference to FIG. 70, by executing guidelines and protocols link 6210, the physician may be linked to a guidelines and protocols interface 7000 (step 1116 FIG. 11). Page 7000 may provide the physician with links to guidelines pertinent to the devices the physician is implanting. Therefore, page 7000 is preferably customized by what devices the physician has implanted. The guidelines are represented as links in page 7000. When the physician executes the link, they may be transferred to another web page displaying the respective document. Alternatively, the document can be downloaded to the physician's computer. Interface 7000 helps gives the physician easy access to the device guidelines. This is not patient identifiable secure data on page 7000, therefore no encryption is necessary.

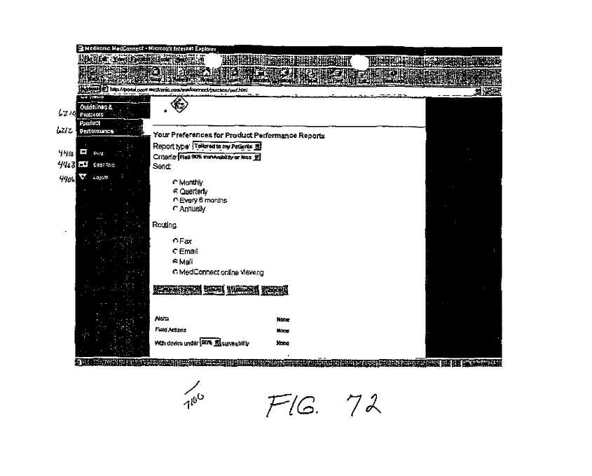

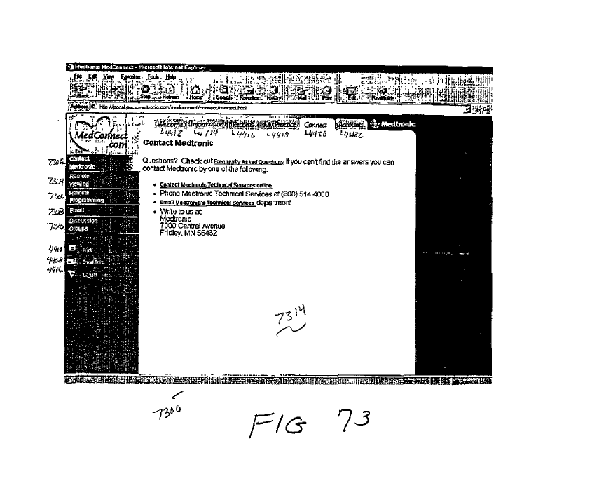

With reference to FIGS. 71-72, by executing product and performance link 6212, the physician is linked to a product and performance interface 7100 (step 1118 FIG. 11). Interface 7100 allows the physician to link to performance reports related to devices the physician has implanted. By executing the links the physician may be directed, for example to another server or network file giving the latest reports on an implantable device's operation, testing, and reliability. Further, the physician is allowed to choose how often interface 7100 polls for performance reports, how the reports are transmitted to the physician, and how the report is tailored. Interface 7100 will preferably post links to performance reports based upon a relevance criteria selected by the physician. The performance reports may be expected to help keep the physician up to date on what products are performing the best.

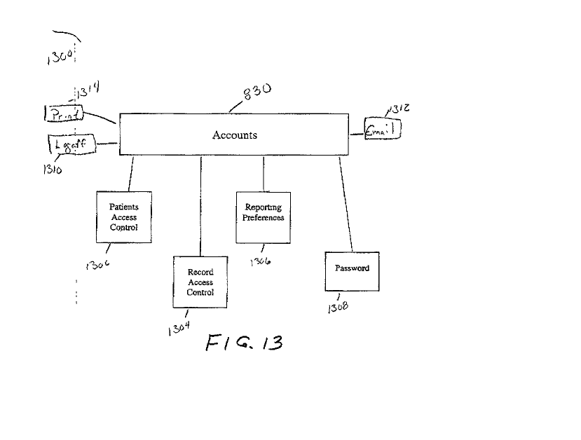

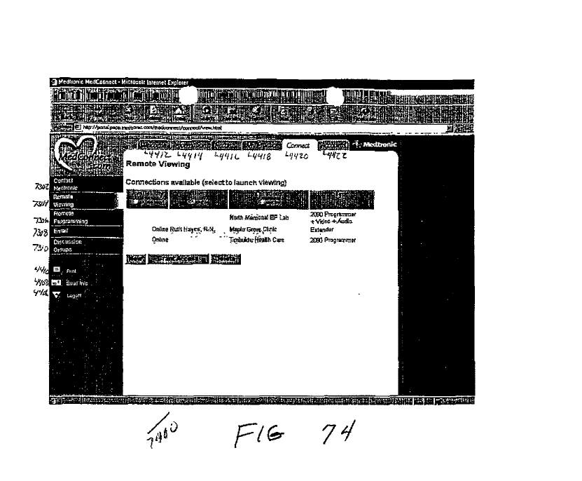

With respect to FIG. 12, connect interface architecture diagram 1200 is shown. After executing connect link 4420 the physician is linked to connect interface 7300 (step 826). With respect to FIG. 73, connect interface 7300 may provide access to other network or server files or utilities, including: Contact Medtronic link 7302; Remote Viewing link 7304; Remote Programming link 7306; Email link 7308; and Discussion Groups link 7310.

Steps 1202, 1204, and 1206 are substantially the same as steps 814, 816, and 818 respectively and therefore reference may be made to the operation of links 44064410 discussed above. Further, links 4412-4422 function substantially the same on connect interface 7300 as they did on welcome interface 4400.

With reference to FIG. 73, by executing a contact manufacturer link 7302, the physician is connected to a contact Medtronic interface 7314 (step 1208 FIG. 12). Interface 7314 allows the physician to contact the implantable device manufacturer directly. For example, interface 7314 may provide direct contact information such as an address, telephone number, and a direct email to the device manufacture's technical services department. Because there is no private patient data on page 7300 there is no need for encryption.

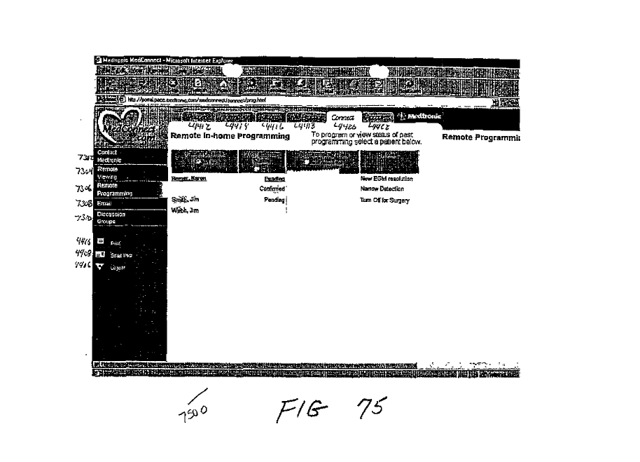

With reference to FIG. 74, by executing remote viewing link 7304, the physician is linked to remote viewing interface 7400 (step 1210 FIG. 12). Interface 7400 allows the physician to directly contact, e.g. over the Internet, technical support personal, other physicians around the world, or the physician's patients who are online and logged onto patient portal 300 or physician portal 800. The physician may first select the individual the physician wishes to communicate with, and then grants access to the remote viewing interface to that individual. Page 7400 makes it easier for the physician to directly communicate with anyone who is online at the same time as the physician.

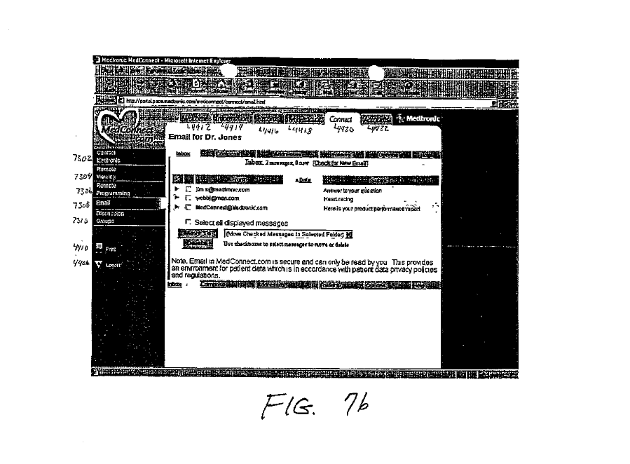

With reference to FIG. 75, by executing remote programming link 7306, the physician is linked to remote programming interface 7500 (step 1212 FIG. 12). Interface 7500 allows the physician to monitor the programming of a patient's implantable device directly from physician portal 800. All patients treated by the physician and having implantable devices may be listed, for example, together with their programming status, the date of the last programming, and any notes concerning the programming. By using interface 7500 the physician is able to quickly examine patient device programming information without referencing any documents or contacting the patient. Because there will potentially be patient data on page 7500, encryption will typically be desirable if a public network is used.

In addition to the functions discussed above, further portal-based functions may be provided that may aid the physician, or authorized staff, in administrative tasks relating to implant patients. For example, the patient portal scheduling of follow-up appointments discussed above may be mirrored by physician office scheduling utilities. Administrative procedures such as billing and coding may be automated and forwarded, via the portal server or network, or other communications system, to a billing agency. Follow-up data may be automatically collected from remote monitoring equipment, and if exception conditions, such as malfunction or conditions warranting professional intervention or indicating a change in treatment regimen, a contact priority list and mode of contact may be specified for a particular patient or for all the patients of a particular physician or clinical entity.

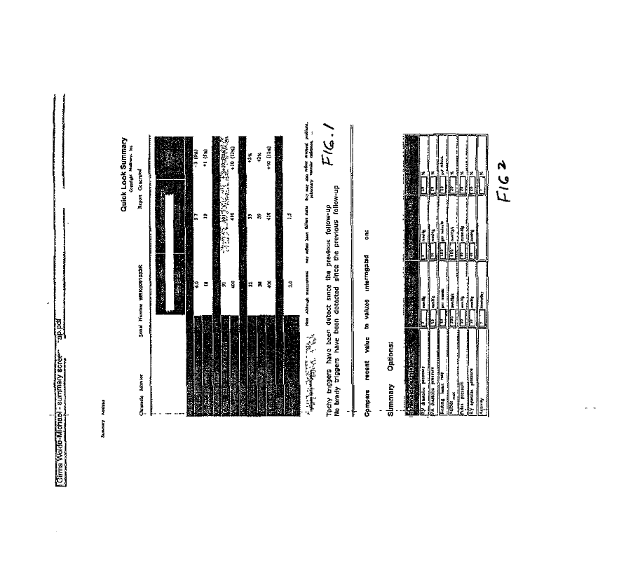

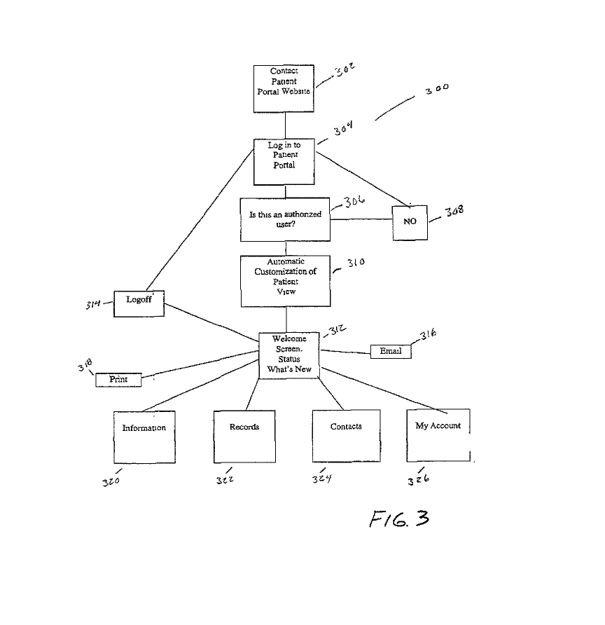

An embodiment of the present invention also provides for a chronicle or summary report of patient data, either on an individual or an aggregate level. An online interface for a chronicle summary report is depicted in FIGS. 1 and 2. The summary report provides a critical higher-level summarization of collected data. Users may reference this report in order to access an overall summary of IMD status. This interface allows patients or physicians to tell at a glance that an IMD or patient status is without complications, or alternately whether intervention in patient status may be indicated.

The summary report provides a useful higher level compilation of collected data. An individual user, such as an implant patient, can tell their general condition with minimum inquiry. Users may optionally rely on being affirmatively notified when out of range data is found, e.g., using push technology. Such notification may free a user from examining every data set on a minute level. The collection and summarization of data may proceed as follows. Initially, data is collected by the implanted device. This may be, for example, continuously monitored heart rate, patient activity, and pressure data; or blood gas, oxygen saturation, lung wetness, edema, respiration rate, or posture, as relevant to device operation and patient wellness. In a preferred embodiment, a variable is used to determine that the patient is in a state repeatable from day to day, for example, based on the heart rate during sleep, or activity of daily living calculations, or posture sensors. Upon determination that a baseline or measurement-conducive condition is in effect, data may be retrieved for analysis. For example, this may proceed by means of both home monitors and programmer devices, with the data sent over the network of the portal service provider or administrator. This data may be forwarded to a third party data processing provider, or it may be routed to portal service provider/administrator servers for analysis and storage. In addition to data gathered by implantable devices, data may also be collected that is measured outside the body such as edema, weight. The data may be combined with past patient data or follow-up records to form a continuous and uniform body of data. From this body of data, clinically relevant measurements may be derived. For example, the average of up to the three previous daily averages may be extracted. This simple analysis algorithm may be expected to evolve and become more sophisticated as further information is compiled and exploited.

Returning to the individual patient scope, the values and amount of change may be compared against clinical norms, and flagged for the user if they are abnormal. This flagging or notification may include, for example, the use of emailed reports, faxed reports, or push technology. In a preferred embodiment, the applicable clinical norms may optionally be modified for each patient by the clinician. Ultimately, when sufficient experiential data has been compiled, this model may then serve as a clinical baseline for a patient. When displayed, the data will preferably include: the most recent measurement values; the change in absolute units; the change in percent; the measurements from the previous follow-up for reference and comparison, and the normal ranges for an applicable cohort group. Initially, and prior to such experiential data as may be gathered by the clinician, default normal ranges may be determined by a device manufacturer as a general guideline. When the normal range for each patient are modified for a particular patient, any modifications are saved for future use. To ensure the normal range is based on valid data, users may be allowed to view individual records, as properly redacted to preserve necessary patient privacy. Users can obtain the summary or aggregate data in a variety of ways. For example, the data may be provided with an HTML view optimized for computer displays, as well as a PDF version optimized for printing. Alternately, the data distribution method may include email, fax, handheld devices, or paging devices.

With reference to FIG. 76, by executing email link 7308, the physician is linked to email interface 7600 (step 1214 FIG. 12). Interface 7600 allows the physician to check any of their email on the partial service provider server. The physician may also be allowed to compose and send any new email the physician may wish to send. Interface 7600 may operate as a browser-based email program. Further, because there is the high probability of private data being transferred over the email interface 7600, the interface and the email SMTP payload itself is preferably encrypted.

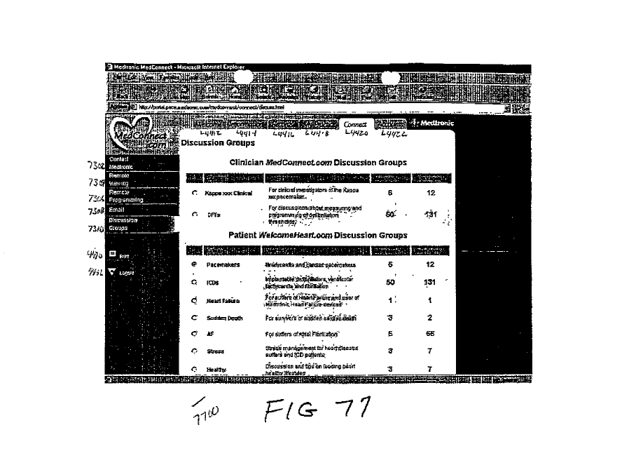

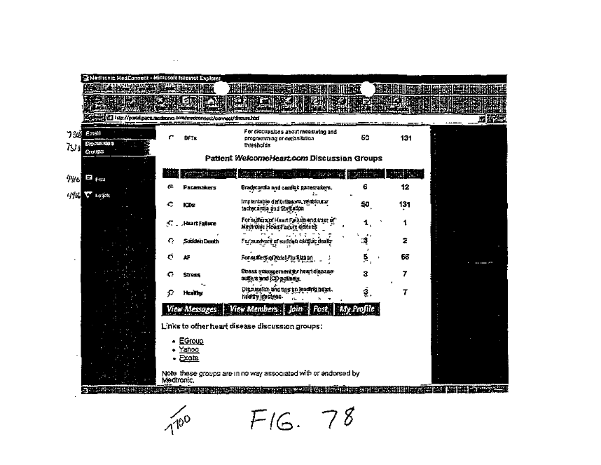

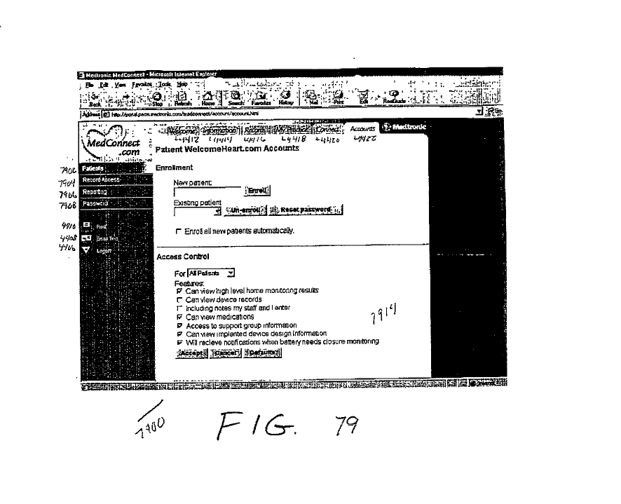

With reference to FIG. 77, by executing discussion groups link 7310, the physician is linked to discussion groups interface 7700 (step 1216 FIG. 12). Interface 7700 allows the physician to choose from a plurality of discussion groups listed which may be administered in a Usenet manner. The devices that the physician implants, or the devices implanted in the physician's patients may be used to customize the discussion groups presented to the physician. The physician can choose to view the messages on the discussion page, view the members on the discussion page, join in the discussion page, post a message on the discussion page, or examine the physician's profile that is displayed to others on the discussion page.

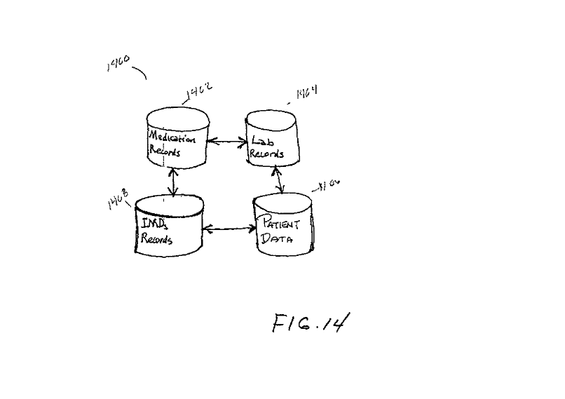

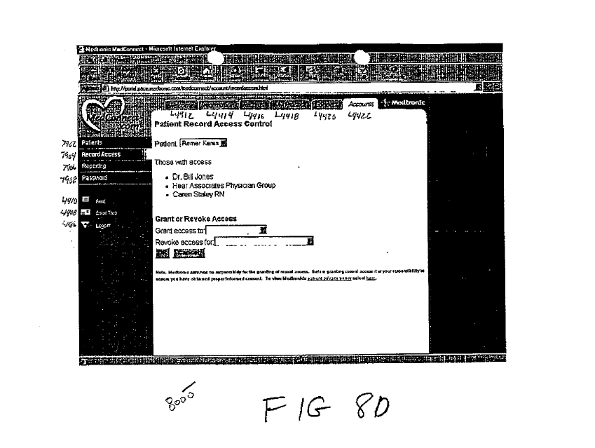

With respect to FIG. 13, accounts interface architecture diagram 1300 is shown. After executing accounts link 4422, the physician may be linked to accounts web page 7900 (step 828). With respect to FIG. 79, accounts interface 7900 may offer additional server or network links, including: Patients link 7902; Record Access link 7904; Reporting link 7906; and Password link 7908.

Steps 1310, 1312, and 1314 are substantially the same as steps 814, 816, and 818 respectively and therefore reference may be made to the operation of links 4406-4410 discussed above. Further, links 4412-4422 may be implemented to function substantially the same on accounts interface 7900 as with welcome interface 4400.

With reference to FIG. 79, by executing patient's link 7902, the physician is linked to patient accounts interface 7914 (step 1302 FIG. 13). Interface 7914 allows the physician to control what a particular patient or group of patients can view upon accessing patient portal 300. The physician may enter the patient or patient selection criteria and then has a listing of options to choose from, including but not limited to: allowing the patient to view high level home monitoring results; allowing the patient to view device records; allowing the patient to view the physician's or their staff's notes; allowing the patient to view their medications; allowing the patient to access support group information; and allowing the patient to view device design information.

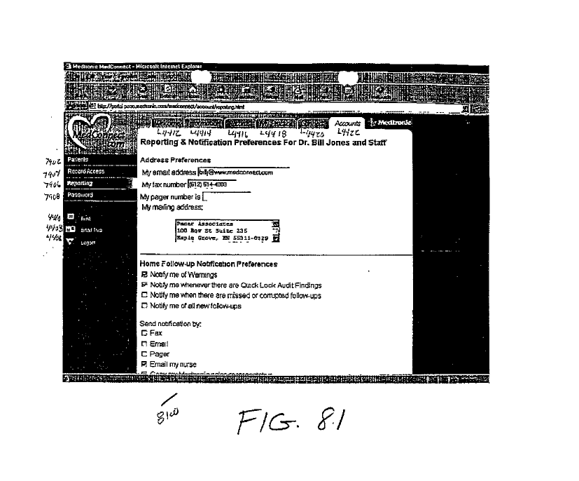

With reference to FIG. 80, by executing record access link 7904, the physician is linked to record access interface 8000 (step 1304 FIG. 13). Interface 8000 allows the physician to control who has access to the physician's records. Page 8000 preferably also gives a listing of all individuals and entities with access already granted and those individuals and entities which have submitted patient permission for access to records, where necessary.

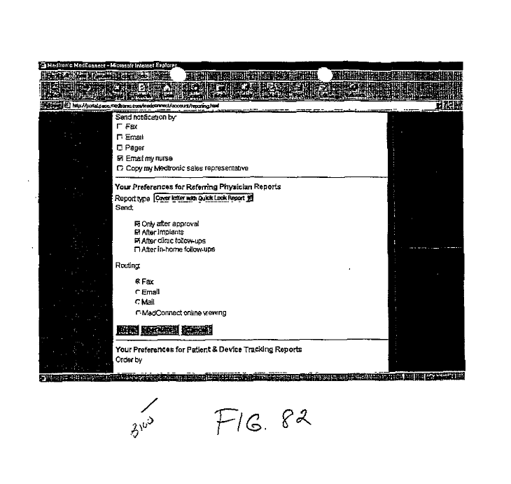

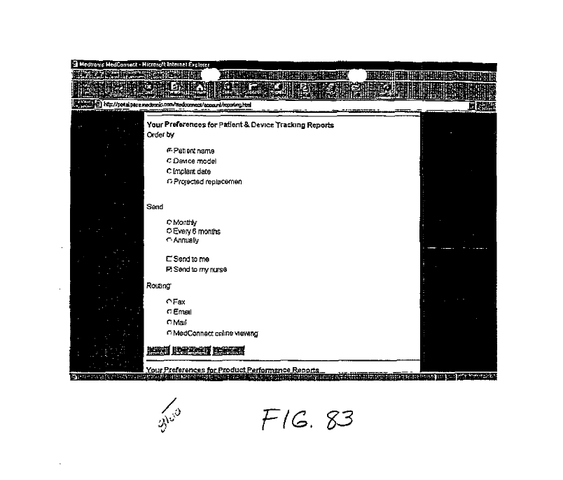

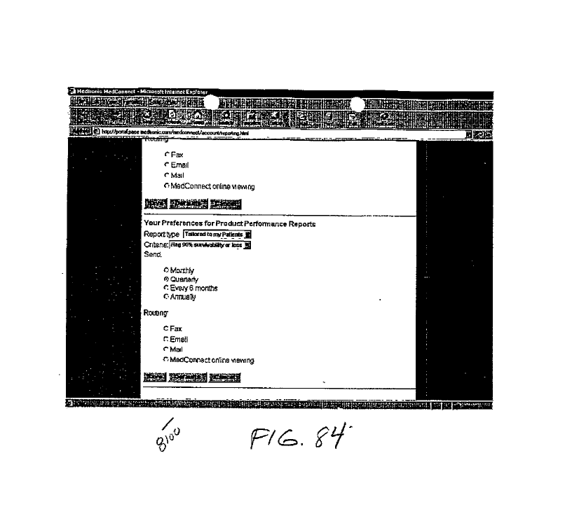

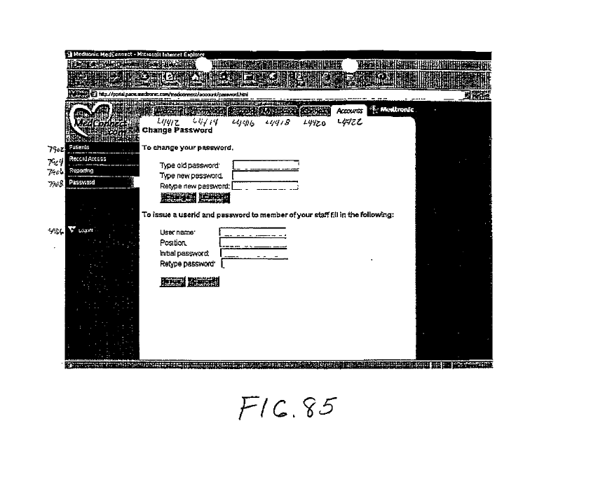

With reference to FIGS. 81-84, by executing reporting link 7906, the physician is linked to reporting web page 8100 (step 1306 FIG. 13). Page 8100 allows a physician to select their preferences for receiving reports and notification of events. For example, the physician can input an email address; fax number, pager number, or a mailing address. Further, the physician is allowed to choose how they receive these reports and notifications. The physician may also be able to choose how patients receive their home follow-up notifications. The physician can also choose how and how often he or she receives referring physician reports, patient and device tracking reports, and product performance reports.

With reference to FIG. 85, by executing password link 7906, the physician is linked to change password interface 8500 (step 1308 FIG. 13). Page 8500 allows the physician to change his or her passwords, and to issue a user id and password to a member of the physician's staff for authentication of a trusted third party or agent.

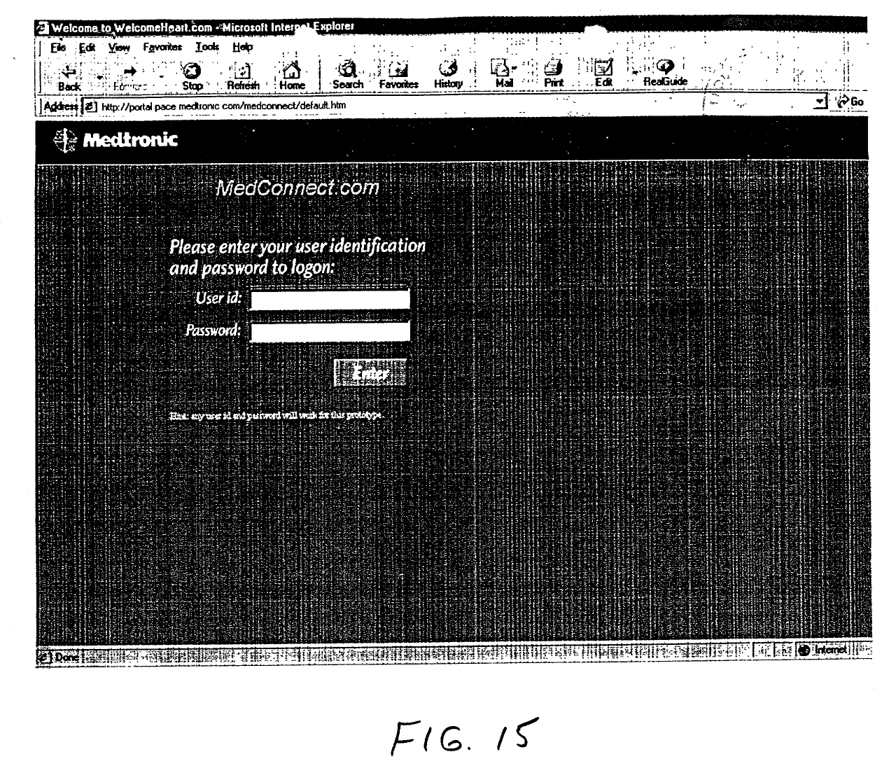

With reference to FIG. 14, data record interaction diagram 1400 shows the interaction between medication records 1402, lab records 1404, patient data 1406, and IMD records 1408. The interaction of records 1402-1408 may be expected to and help the physician in monitoring a patient having an IMD. In addition to the provision of a portal environment for patients and physicians, other portals may also be provided. For example, research engineers at a university or within a device manufacturer may be provided a portal from which large aggregate bodies of patient and device empirical data may be derived. Other users which may be provided with an appropriately limited portal environment may include clinical or other care provider technical or administrative staff, or device manufacturer sales, marketing, or management personnel. This may be provided, for example, in a manner in which patient information may not be matched with an individually identifiable patient, but only in relation to relevant characteristics which do not identify the patient. In a preferred embodiment, the aggregate data is amassed in a manner by which various distributed databases, which may have different administrators, are integrated into a uniform format or field structure, thus allowing for meaningful comparisons across databases and demographic groups.

In a preferred embodiment of the present invention, the portal interface presented to a user is dynamically generated to reflect up-to-the-minute information in the relevant areas. Thus, all relevant information existing on the portal administrator/service provider may be dynamically added to the welcome or analogous portal interface upon user logon. This dynamically-generated information may consist of links, such as html links to other information, or it may consist of viewable data.

It will be appreciated that the present invention can take many forms and embodiments. The true essence and spirit of this invention are defined in the appended claims, and it is not intended that the embodiment of the invention presented herein should limit the scope thereof. As to every element, it may be replaced by any one of infinite equivalent alternatives, only some of which are described in the specification.

What is claimed is:

1. A data communications server system, comprising:
a computerized network of patient nodes and clinician nodes; and
means for the consolidation and distribution of individual or aggregate patient scheduling, treatment regimens, and outcome data.

2. The data communication server system of claim 1, wherein at least a portion of the patient data is collected by implanted medical devices.

3. The data communications server system of claim 1, wherein the treatment regimens distributed comprise instructions to implanted medical devices.

4. A computerized method of collecting and utilizing distributed patient and clinician data, comprising the steps of:
a. providing a data communications network having a plurality of nodes from which each node may access, directly or indirectly, a central server system;
b. providing to the network plurality of nodes a computerized interface to resources of the server;
c. gathering via at least one of said plurality of nodes of the network node computerized interfaces individual patient information;
d. aggregating the patient information; and
e. distributing the patient information to network nodes administered by clinicians.

5. The computerized method of claim 4, wherein the central server system comprises a network of servers.

6. The computerized method of claim 4, wherein the computerized interface to the central server system is implemented as a html browser utility.

7. The computerized method of claim 4, wherein the resources of the central server system comprise a body of empirical data regarding implantable medical devices.

8. The computerized method of claim 7, wherein the resources of the central server system further comprise a system of comparing and analyzing the body of empirical data.

9. The computerized method of claim 7, wherein the empirical data regarding implanted medical devices comprises data identifiable to individual patients.

10. The computerized method of claim 9, wherein the data identifiable to individual patients may be accessed by the individual patients to which this data pertains.

11. The computerized method of claim 10, wherein the data identifiable to individual patients is protected by a encryption protocol when accessed.

12. The computerized method of claim 11, wherein the security protocol protecting the data identifiable to individual patients is a secure socket layer.

13. The computerized method of claim 11, wherein the security protocol protecting the data identifiable to individual patients is the https protocol.

14. The computerized method of claim 11, wherein a user attempting to access data identifiable to an individual patient must authenticate themselves prior to receiving the data.

15. The computerized method of claim 14, wherein the authentication to which a user is subject comprises strong authentication.

16. The system of collecting and utilizing distributed patient and clinician data of claim 4, wherein the step of aggregating the patient information further comprises the step of removing patient data that may provide individual identification of a patient.

17. A real-time information management system for implantable medical devices (IMDs), comprising:
a computerized data communication server network that allows patients to view, analyze and display data stored on their IMDs;
a server-based interface to disseminate to patients information about their IMDs;
means for chronic heart rhythm monitoring; and
means for provision of consultation for therapy and clinical care in real-time.

18. The real-time information management system of claim 17, wherein the information about patient IMDs comprises technology developments, clinical trials, and support-group information.

19. A computerized method of communicating in real time between patients, clinicians, and implanted medical devices comprising the steps of:
a. capturing patient implanted device data;
b. storing the implanted device data on a central server system;
c. analyzing and distributing aggregate patient implanted device information;
d. displaying patient-specific data in real time over a public network; and
e. dispensing therapeutic and clinical care based upon the implanted medical device information.

20. The computerized method of claim 19 wherein the patient is able to monitor clinical care and therapy.

21. The method of claim 19 wherein the displaying of patient specific data over a public network is done using a secure protocol with an authenticated client.
